(19) United States
(12) Patent Application Publication
(10) Pub. No.: US 2005/0060395 A1
(43) Pub. Date: Mar. 17, 2005

(54) Network global expectation model for rapidly quantifying network needs and costs

(75) Inventor: Steven K. Korotky, Toms River, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: LUCENT TECHNOLOGIES INC.

(21) Appl. No.: 10/661,747

(22) Filed: Sep. 12, 2003

(51) Int. Cl. G06F 15/173

(52) U.S. Cl. 709/223

(57) ABSTRACT

In the network global expectation model of the present invention, expectation values evaluated over the entire network are used as a multi-moment description of the required quantities of key network and network element (NE) resources and commensurate network costs. The network global expectation model of the present invention naturally and analytically connects the global (network) and local (network element) views of the communication system, and thereby may be used as a tool to gain insight and very quickly provide approximate results for the preliminary evaluation and design of dynamic networks. Further, the network global expectation model of the present invention may serve as a valuable guide in the areas of network element feature requirements, costs, sensitivity analyses, scaling performance, comparisons, product definition and application domains, and product and technology roadmapping.

### FIELD OF THE INVENTION

This invention relates to the field of optical networks and more specifically, to rapidly quantifying the needs and costs of optical networks.

### BACKGROUND OF THE INVENTION

The technology and architecture for circuit and packet communication networks continue to evolve, and converge. Fundamental to the comparison and selection of network architectures and their technological implementations is the total cost of ownership of the network. This cost includes the expenses for capital equipment (CAPEX), network operation (OPEX), and network management (MANEX). While operational and management expenses represent the largest share of the total cost of ownership, capital costs are a considerable and highly visible portion of the initial investment. Equipment cost is therefore a very important factor in the choice of architecture and technology. Therefore, a model for very quickly gauging the network equipment needs and costs is needed.

### SUMMARY OF THE INVENTION

The present invention provides a network global expectation model for estimating the number of network elements, network elements characteristics, and costs of communication networks using analytic formulae. The network global expectation model includes the calculation of both the mean value and variance of all key network quantities and may be applied to a wide range of topologies, architectures, and demand profiles.

The network global expectation model of the present invention uses expectation values as a multi-moment description of the required quantities of key network and network element (NE) resources and commensurate network costs. This approach naturally, analytically, and accurately connects the global (network) and local (network element) views of the communication system. As a result, the model may be used as a tool to gain insight and quickly provide approximate results for preliminary network evaluation and design, element feature requirements, costs, sensitivity analyses, scaling performance, comparisons, product definition and application domains, and product and technology road-mapping.

The network global expectation model of the present invention is adaptable to both increasing and decreasing levels of detail and sophistication of the cost structures. Because of the analytic nature of the model the estimates of quantities may be computed much faster than is possible with detailed routing solvers, and so the model is ideally suited to network analyses in dynamic operating and technological environments. The uncomplicated and transparent accounting of network elements, systems, and costs inherent in the network global expectation model of the present invention constitutes a framework for the cooperative exchange of critical planning information on evolving network needs across the many sectors of the communication business.

### BRIEF DESCRIPTION OF THE DRAWINGS

The teachings of the present invention can be readily understood by considering the following detailed description in conjunction with the accompanying drawings, in which:

FIG. 1 depicts a high level abstract representation of a mesh network wherein an embodiment of the present invention may be applied;

FIG. 2 depicts a high level representation of a prototypical backbone network wherein an embodiment of the present invention may be applied;

FIG. 3a depicts a high level block diagram of an exemplary cross-connect and line system arranged to illustrate five two-way ports (North, South, East, West, and Termination) service by a cross-connect wherein an embodiment of the present invention may be applied;

FIG. 3b depicts a high level block diagram of the system of FIG. 3a arranged to illustrate five one-way ports (five inputs and five outputs);

FIG. 4 graphically depicts a plot of the termination-to-termination traffic, τ, for uniform demand as a function of the number of nodes, N, and total network traffic, T.

FIG. 5 graphically depicts a plot of the mean traffic on a link including idle restoration channels for uniform demand as a function of the number of nodes N and total network traffic T;

FIG. 6 depicts a high level block diagram of two cross-connect ports and the relationship among the local ADD, DROP and THRU channels;

FIG. 7 depicts a high level block diagram of an exemplary Bandwidth Management Architecture using both optical and electronic cross-connects;

FIG. 8 graphically depicts an illustrative comparison of bandwidth management costs; and

FIG. 9 graphically depicts a contour map of the total cost of a mesh network with uniform demand as a function of the number of nodes N and total traffic T.

### DETAILED DESCRIPTION OF THE INVENTION

Although various embodiments of the present invention herein are being described with respect to various communication networks, such as backbone, fiber-optic transport networks and mesh networks, it should be noted that the specific communication networks are simply provided as exemplary environments wherein embodiments of the present invention may be applied and should not be treated as limiting the scope of the invention. It will be appreciated by those skilled in the art informed by the teachings of the present invention that the concepts of the present invention are applicable in substantially any network wherein it is desirable to quickly gauge the network equipment needs and costs.

In the present invention, a general formalism of the global network expectation model is developed and application illustrated by considering single-tier backbone networks with location-independent traffic demands. While the methodology presented herein is very general, for specificity the application is described throughout the specification in the context of mesh networks.

As the cost of a network for a specified set of features is considered the metric for comparison of architectures and technologies, the inventor proposes that the total network cost is exactly the sum of the costs of the constituent parts, or elements, of the network. This fundamental accounting of costs may be written mathematically according to equation one (1), which follows:

$${C}_{T} ≡ {\sum }_{i} {c}_{i} , \qquad ( 1 )$$

where C_{T} is the total network cost and cᵢ is the unit cost of the ith component (herein and throughout this disclosure the symbolic notation Σ indicates the summation over the various contributing terms, in this case the many individual components.)

It is usual that there are many components of a given type used throughout the network, and these identical parts share a common cost. In this case using the associative, commutative, and distributive properties of the field of real numbers, equation (1) above may be rewritten according to equation two (2), which follows:

$${C}_{T} = {\sum }_{i} {v}_{i} {c}_{i} , \qquad ( 2 )$$

where again C_{T} is the total network cost, vᵢ is the number of network elements of type i, and cᵢ is the corresponding unit cost of network element of type i.

Without loss of generality it may be assumed that the technology and corresponding unit costs, cᵢ, of the network elements used to construct the network are known, i.e., given apriori. The challenge of network design is to determine the number, vᵢ, and placement of each of the network elements of the given types to minimize the total network cost under the constraint to service a specified traffic demand among the network terminations located at specific geographic locations. The strategy of the model of the present invention is to carefully estimate the products of the network element counts and respective costs while satisfying the external constraints, and thereby to estimate the total network cost using equation (2) above, but without explicitly establishing knowledge of the placement of every individual component within the network.

The sum in equation (2) does not distinguish among the various categories of network elements, but considers each contributing type as atomic (i.e., indivisible). Without changing the value of the sum, terms may be collected that are logically related to one another into a cost subtotal for larger categories of elements. Denoting a general set of categories as α, equation (2) may be rewritten according to equation three (3), which follows:

$${C}_{T} = {\sum }_{α} {\sum }_{i} {v}_{i} ( α ) {c}_{i} ( α ) . \qquad ( 3 )$$

One useful subdivision for separating costs is based on collecting the costs for signal transmission (TRANS) and signal bandwidth management (BWM) into separate terms. In this case equation (3) above may be rewritten according to equation four (4), which follows:

$${C}_{T} = {\sum }_{TRANS} {v}_{i} {c}_{i} + {\sum }_{BWM} {v}_{j} {c}_{j} , \qquad ( 4 )$$

The transmission term might include, for example, objects such as optical transceivers (OT), optical multiplexers (OMUX), and optical amplifiers (OA). The bandwidth management term might include objects such as multi-service platforms (MSP), electronic cross-connects (EXC), optical add/drop multiplexers (OADM), and optical cross-connects (OXC). Of course, which objects are to be associated with particular categories is a matter of architectural choice.

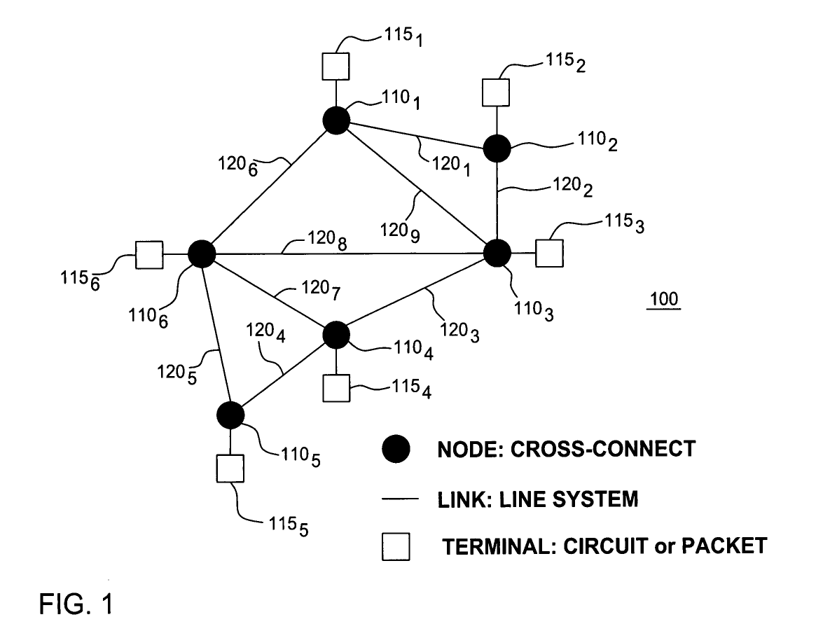

FIG. 1 depicts a high level abstract representation of a mesh network wherein an embodiment of the present invention may be applied. The mesh network 100 of FIG. 1 comprises a plurality of nodes (illustratively 6 nodes) 110₁-110₆ (collectively nodes 110), where traffic may enter and leave the mesh network 100, a plurality of terminals (illustratively 6 terminals 115₁-115₆) (collectively terminals 115) connected to the nodes 110, which are the sources and sinks of traffic in the network 100, and a plurality of inter-nodal links (illustratively 9 links 120₁-120₉) (collectively links 120), which represent the physical segments over which the inter-terminal traffic may be carried, or transported, between the nodes 110. The total number of nodes and links of the mesh network 100 of FIG. 1 are denoted by N and L, respectively. The average degree of node in the mesh network 100 of FIG. 1 is [symbol] δ [symbol] =3 for N=6 nodes and L=9 links.

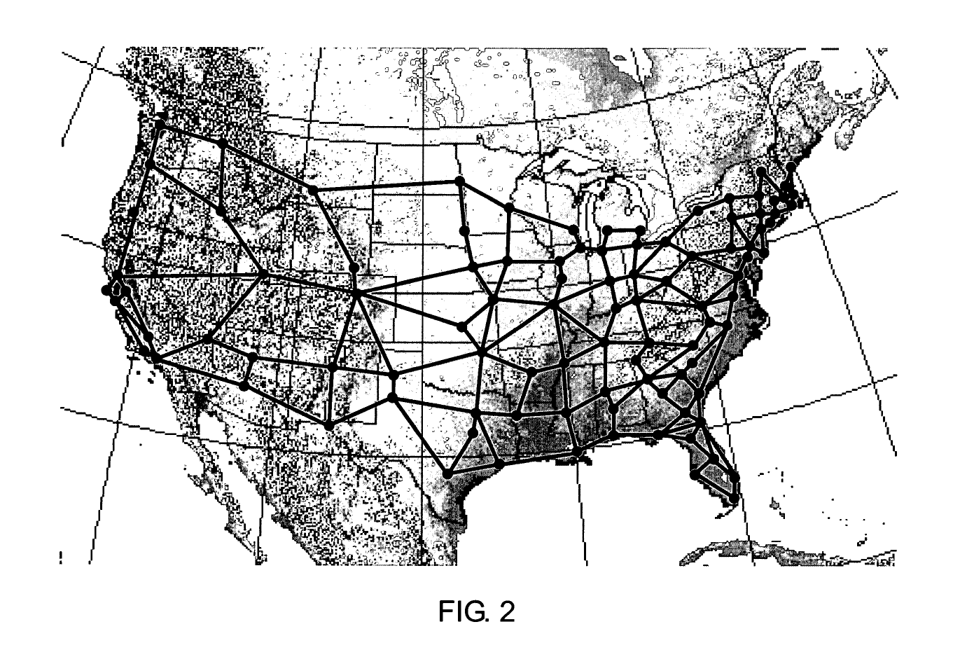

FIG. 2 depicts a map of the United States of America comprising an illustration of an exemplary mesh network, such as the mesh network 100 of FIG. 1, wherein an embodiment of the present invention may be applied. FIG. 2 depicts a core fiber transport network typical of larger inter-exchange carriers of the continental United States. The example network 200 of FIG. 2 illustratively comprises 100 nodes and 171 links. The average degree node is [symbol] δ [symbol] =3.4, and the average number of minimum hops between node pairs is [symbol] h [symbol] =6.6.

As suggested by the view of the mesh networks illustrated in FIG. 1 and FIG. 2, the total network cost, C_{T}, may also be represented by terms that correspond to the L links and N nodes of the network according to equation five (5) or equation six (6), which follow:

$$\begin{matrix}{C}_{T} = {\sum }_{l}^{L} {c}_{l} + {\sum }_{n}^{N} {c}_{n} , \\ or & ( 5 ) \\ {C}_{T} = {\sum }_{LINKS} {c}_{l} + {\sum }_{NODES} {c}_{n} , & ( 6 )\end{matrix}$$

where cᵢ is the cost of the lth link and cₙ is the cost of the nth node. If the first term of equation (5) above is multiplied by the factor L/L and the second term by N/N and note that the expectation value, [symbol] q [symbol] , or average, of a set of values {qᵢ} i=1, m is defined according to equation seven (7), which follows:

$$〈 q 〉 = \frac{1}{m} {\sum }_{i}^{m} {q}_{i} , \qquad ( 7 )$$

then equation (5) above may be rewritten according to equation eight (8), which follows:
C_{T}=L<cᵢ>+N<cₙ>. (8)
Thus, as expressed in Eq. 8 the exact cost of the network may be considered as the sum of the expectation value of the cost of a link times the number of links and the expectation value of the cost of a node times the number of nodes. The global expectation values (cᵢ) and (cₙ) are themselves explicitly defined according to equations (9a) and (9b), which follow:

$$\begin{matrix}〈 {c}_{l} 〉 = {\sum }_{i} {〈 {v}_{i} 〉}_{l} {c}_{i} , \\ and & ( 9 a ) \\ 〈 {c}_{n} 〉 = {\sum }_{j} {〈 {v}_{j} 〉}_{n} {c}_{j} . & ( 9 b )\end{matrix}$$

Note, throughout this disclosure, the bracket notation, [symbol] [symbol] , will be used to denote the expectation value of a variable. In instances when the corresponding set {q} of an expectation value [symbol] q [symbol] may be ambiguous, the right bracket of the expectation value may be followed by a subscript to provide clarification. For example, in equation (9a) above, [symbol] νᵢ [symbol] ₗ indicates an expectation value over the set of links {l} and in equation (9b) above, [symbol] νⱼ [symbol] ₙ indicates an expectation value over the set of nodes {n}. Also regarding expectation values, here the elements qᵢ of the set {q} are not samples of a variable associated with either a discrete or continuous probability distribution, but rather define a distribution.

The relationship of network cost to link and node costs embodied in equations (8-9) above could have served as the starting point of this discussion, however, the inventor has decided to begin the discussion of the present invention instead using equation (1) to firmly establish that the use of expectation values, or averages, to determine the total network cost is not an approximation, but is exact. The approximations of the global expectation model(s) reside instead in the estimation of the expectation values of the quantities of network elements, [symbol] ν [symbol] . Consequently, the predictive capability of the model will depend upon the accuracy of the estimations of these mean values and the applicability of other related assumptions, such as the demand model. As will be demonstrated herein, for many variables the expectation values may be computed exactly from the input variables for a given demand model, while for other variables it is necessary to introduce semi-empirical approximations.

Network and Primary Model Variables

Referring back to FIG. 1 and FIG. 2, a communication network has been defined as the combination of a network graph, denoted G, consisting of a set of N nodes {nᵢ} and set of L connecting two-way links, or edges, {lᵢ}, and a network traffic. The network graph may be represented by the symmetric matrix [g] with elements gᵢⱼ. The pair-wise communication traffic between nodes may be represented by the symmetric demand matrix [d] with elements dᵢⱼ and the total ingress/egress traffic T.

The matrix elements gᵢⱼ are either 0 or 1 in value and specify whether a pair of nodes is connected via a physical link. The summation of all the values of the matrix elements of [g] yields the number of one-way links L₁, which is twice the number of two-way links, L₂. The demand matrix elements dᵢⱼ are either 0 or a positive integer and denote the magnitude of the termination-to-termination traffic in quantized units of some basic measure of communication bandwidth, such as a standardized channel bit-rate, B. The summation of all the values of the matrix elements of [d] yields the number of one-way demands D₁, which is twice the number of two-way demands D₂. It should be noted that, generally the diagonal elements of [g] and [d] are zero. The demands are also often referred to as logical links.

Often the channel bit-rate is not explicitly given for the network of interest. Instead, the total ingress/egress traffic T and number of demands are specified. In that case a value of the termination-to-termination τ traffic must be deduced, and from this a logical value of B may be chosen. It is for this reason that here the total two-way traffic is considered T₂, which is one-half the total one-way traffic T₁, to be an independent variable and for τ to be a dependent variable. Having chosen T as an independent variable, a complete set of model inputs is obtained, namely; G(N,L), D, and T together with a demand model. The inventor demonstrates herein that all other variables of interest may be derived from these variables.

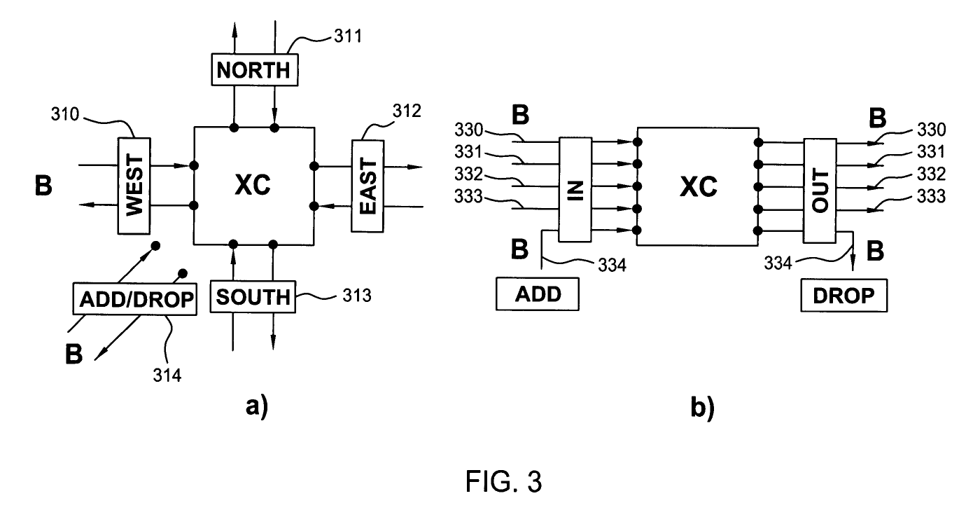

In counting quantities such as links, demands, traffic, etc. it is necessary to distinguish between one-way (simplex) and two-way (duplex) variables. As indicated above, the number of two-way links, demands, and traffic is one-half the corresponding number of one-way values. These relationships are illustrated in FIG. 3a and FIG. 3b (described below), and formally summarized according to equations (10a), (10b) and (10c), which follow:

| | | |
|---|---|---|
| Links: | L = L₂ = L₁/2 | (10a) |
| Total Traffic: | T = T₂ = T₁/2 | (10b) |
| Total Demands: | D = D₂ = D₁/2 | (10c) |

FIG. 3a depicts a high level block diagram of an exemplary cross-connect and line system wherein an embodiment of the present invention may be applied. The cross-connect and line system 300 of FIG. 3a illustratively comprises five two-way ports 310-314 (illustratively, North, South, East, West and Termination ports) serviced by the cross-connect 320.

FIG. 3b depicts a high level block diagram of the cross-connect and line system 300 of FIG. 3a arranged to illustrate five one-way ports 330-334 (five input ports and five output ports). It is typical to define a two-way channel of bandwidth B as the combination of two one-way channels, XY and YX, each of bandwidth B. That is the single value B describes both the one-way and two-way channels. This is evident in the examples depicted in FIG. 3a and FIG. 3b. Also, considering the trivial case of two nodes, N=2, and one two-way link, L=1, the total one-way traffic is T₁=2B, and the total two-way traffic is T=T₂=B. Of course, so long as one-way or two-way variables are used consistently, or the proper conversion is made, the results and conclusions are the same. For example, B=T₂/D₂=T₁/D₁. Referring back to FIG. 3a and FIG. 3b, it should be noted that the numbers of one-way and two-way ports are identical, i.e., P₁=P₂. Also, the channel bit-rate B, or alternatively the termination-to-termination traffic, τ, describes both the one-way and two-way traffic between terminating nodes.

The output variables that are determined by the network global expectation model given the small number of inputs are many. Among them are the termination-to-termination traffic rate and expectation values and variances for the degree of node, number of hops, wavelengths on a link, traffic on a link, restoration capacity, number of ports on a cross-connect, total capacity of a cross-connect, and percentage add/drop at a node. With these expectation values and a cost model for the individual elements the total network cost may be computed.

Single-Tier Networks with Location-independent Demands

To introduce the global expectation model a single-tier network consisting of a set of peer nodes and uniform, fully-connected inter-terminal demands is first considered. While this may seem restrictive, in fact the network global expectation model may be applied to a wide range of network topologies, architectures, and demand profiles. This will become evident as the expectation values and general relationships that are independent of the details of the topology, architecture, and demand are formulated and derived. Additionally, the specific results for uniform demand may also be useful in gauging key quantities for non-uniform demand profiles. For example, in the case of non-uniform demand that is not correlated with the absolute or relative location of terminal pairs (eg. random demand), uniform demand may be considered an average representation on the non-uniform demand. Also, one may envision restructuring an otherwise non-uniform network by grooming the traffic and truncating the set of nodes to produce a core network approaching the characteristics of a single-tier network with uniform demand. Having developed the general formalism here, in future works additional topologies, architectures, and profiles of interest will be explicitly considered.

Most core networks carry symmetric traffic between nodes, and so working with two-way variables is the norm. However, in some instances visualizing and counting one-way variables may be more intuitive, such as tracking a one-way demand from source to destination. Of course following two-way demands from termination to termination is equivalent. In the following, expressions will be explicitly developed using both one-way and two-way input variables for utmost clarity. In very many cases the definition of output variables is such that the values do not change when switching between the one-way and two-way perspectives, as was previously illustrated.

Throughout the following, the model of the present invention will be applied to estimate key characteristics of two example networks. The first example network is the network 200 depicted in FIG. 2, which consists of 100 nodes and 171 links, uniform demand, and total two-way network traffic of 5 Tb/s. A second example network (not shown) is of similar topology and consists of 25 nodes and 42 links, uniform demand, and total two-way traffic of 1 Tb/s.

Number of Demands

The number of nodes, N, the total two-way traffic, T, and number of two-way links, L, are inputs of the model. The traffic demand is also an input of the model. The total number of demands is explicitly and, of course, straightforwardly related to the numbers of demands terminating at the individual nodes. The one-way demands terminating at node i may be related to the elements of the demand matrix [d], viz. dᵢ=Σ^{N}dᵢⱼ. Summing the terminating one-way demands, the total one-way and total two-way demands may be related to the mean number of terminating demands at a node, [symbol] d [symbol] ₙ, according to equations (11a) and (11b), which follow:

$$\begin{matrix}{D}_{1} = {\sum }_{i}^{N} {d}_{j} = \frac{N}{N} {\sum }_{i}^{N} {d}_{i} = N {〈 d 〉}_{n} , \\ and & ( 11 a ) \\ D ≡ {D}_{2} = \frac{{D}_{1}}{2} = \frac{1}{2} N {〈 d 〉}_{n} . & ( 11 b )\end{matrix}$$

The above expressions in equations (11a) and (11b) are independent of the details of the demand model. The uniform demand model specifies that there is a one-way demand from every node to every other node, or a two-way demand between every node-node pair of the N nodes. Thus, the expression for uniform demand may be characterized according to equations (11c), (11d) and (11e), which follow: [symbol]
dₙ=N−1 (11c)
and
D₁=N(N−1) (11d)
D≡D₂=N(N−1)/2 (11e)
Using the equations above, the number of two-way demands may be calculated for the two example networks described above. For example, the number of two-way demands (logical links) for the example network 200 of FIG. 2 having N=100 nodes and L=171 physical links is D=4,950. The number of two-way demands for the second example network described above having N=25 nodes and L=42 links is D=300.
Termination-to-Termination Traffic

The value of the termination-to-termination traffic, τ, can be computed exactly as the ratio of the total ingress/egress traffic, T, and total number of two-way network demands, D, terminating at all nodes. As such, the value of termination-to-termination traffic, τ, may be characterized according to equations (12a) and (12b), which follow:
τ≡T₁/D₁=T₂/D₂=T/D, (12a)
and for uniform demand
τ≡T/[N(N−1)/2]. (12b)
The total traffic, T, and total number of demands, D, define the termination-to-termination traffic, τ, as indicated by the relationship expressed in Eq. 12a, which is independent of the demand model. As the total traffic and the number of demands define the termination-to-termination traffic, τ, the value of τ is uniquely specified and as such its variance is exactly zero.

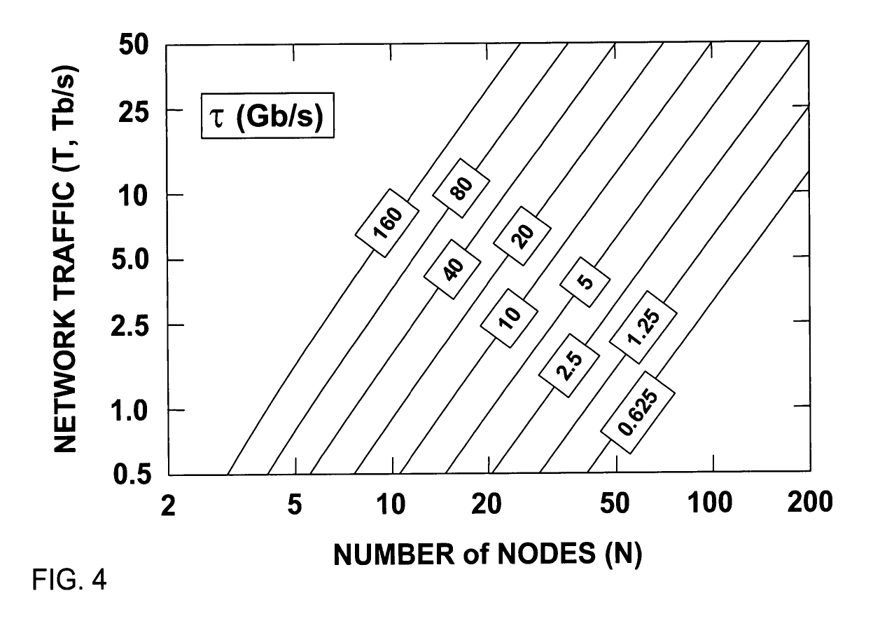

FIG. 4 graphically depicts a plot of the termination-to-termination traffic, τ, for uniform demand as a function of the number of nodes, N, and total network traffic, T. In FIG. 4, the termination-to-termination traffic, τ(N,T) for uniform demand is graphed as a function of the number of nodes, N, and total two-way traffic, T, using a contour plot.

The termination-to-termination traffic, τ, for the example network 200 of FIG. 2 having N=100 nodes, L=171 links and total traffic of T=5 Tb/s is τ=1.01 Gb/s. This may be compared to τ=3.3 Gb/s for the example network having N=25 nodes, L=42 links, and total traffic of T=1 Tb/s. The channel bit-rate is smaller for the larger network because the number of demands for the larger network is significantly greater than for the smaller network.

Degree of Node

The average degree of a node, [symbol] δ [symbol] , (i.e. [symbol] δ [symbol] ₙ), is calculated straightforwardly by summing the number of one-way (directed) links and dividing by the number of nodes. Referring back to the matrix representation [g] of the network graph of FIG. 1 and FIG. 2, the average degree of node may be characterized according to equations (13a) and (13b), which follow:

$$\begin{matrix}{δ}_{i} = {\sum }_{j}^{N} {g}_{ij} \\ and so & ( 13 a ) \\ 〈 δ 〉 = \frac{1}{N} {\sum }_{i}^{N} {\sum }_{j}^{N} {g}_{ij} = \frac{{L}_{1}}{N} = \frac{2 {L}_{2}}{N} = \frac{2 L}{N} . & ( 13 b )\end{matrix}$$

This compact expression for (δ) is exact and independent of the demand model.

The variance σ²(q) and standard deviation σ(q) of the set of values for the network variable q, are characterized according to equations (13c) and (13d), which follow:

$${σ}^{2} ( q ) = \underline{1} {\sum }^{m} {( {q}_{i} - 〈 q 〉 )}^{2} , \qquad ( 13 c )$$

mⁱ
which may be rewritten as
σ²(q)≡ [symbol] q² [symbol] − [symbol] q [symbol] ². (13d)
As previously noted, the set {q} is not a sampled data set, but defines the distribution. Furthermore, the standard deviation of a network variable is not an indication of the accuracy or error of the model, but rather it is a measure of the variation of the number of network elements or subsystems from locale to locale across the network. Note too that the value of the mean is independent of the variance. Thus, for example, the total cost for bandwidth management may be accurately predicted even while some nodes are smaller and cost less, and others are larger and cost more.

The variance of the degrees of nodes is defined according to equation (13e), which follows:
σ²(δ)≡ [symbol] δ² [symbol] − [symbol] δ [symbol] ², (13e)
and so like δᵢ and [symbol] δ [symbol] , σ²(δ) is a function only of the network graph, G. Note, however, unlike [symbol] δ [symbol] there is no closed form expression for σ²(δ) as a function only of N and L. Rather the variance of the degrees of nodes implicitly depends upon the details of the network connectivity and must be computed from a representation of the graph, such as [g] or an equivalent link-list. If the network graph, or equivalently the link-list, is provided then functions of the degrees of nodes, such as the variance, may be computed exactly.

As [symbol] δ [symbol] and L are directly proportional and the variance of δ is more closely related to [g], in some situations it may be useful to consider [symbol] δz,901 as the independent input variable and L as the dependent output variable.

For the example network 200 of FIG. 2 having N=100 nodes and L=171 links, the mean degree of node is [symbol] δ [symbol] =3.4. The standard deviation of the nodal degree obtained from the network graph (FIG. 2) is σ(δ)=1.1. By design, the mean degree of node and standard deviation of the nodal degree for the second example network having N=25 nodes and L=42 links are also [symbol] δ [symbol] =3.4 and σ(δ)=1.1.

Number of Hops

The number of hops between a pair of nodes is defined as the minimum number of inter-nodal links traversed by a demand between the terminating node pair. Algorithms for determining the minimum number of hops hᵢⱼ between node pairs (i,j) from the matrix representing the network graph [g] are well known, and so [h] and [symbol] h [symbol] may be readily computed given a demand model. The expectation value of the minimum number of hops is over the set of demands, (e.g., [symbol] h [symbol] _{d}), and may be characterized according to equation (14a), which follows:

$$〈 h 〉 = \frac{1}{D} {\sum }_{i < j}^{ D} {h}_{ij} = \frac{1}{2 D} {\sum }_{i , j}^{D} {h}_{ij} . \qquad ( 14 a )$$

If the network graph and demands are provided, then (h) may be computed exactly. However, [symbol] h [symbol] may also be approximated for uniform, location-independent, or random demands with knowledge only of the number of nodes and number of links, as will be discussed in more detail below.

The dependency of the average number of hops on the number of nodes N and number of links L may be formulated by considering the schematic of the network graph. If the outer boundary of the N nodes of a planar network arranged is visualized roughly as a square with √N nodes on each of the two orthogonal sides, the characteristic distance between nodes measured in units of hops scales as √N for uniform demand. In addition, the mean number of hops decreases as the number of links L increases for fixed N. An approximate analytic relationship describing the dependency of the mean number of hops on the number of nodes N and the mean degree of the nodes, [symbol] δ [symbol] , may be derived by considering a single node at the center of a regular network of constant degree, δ. In this case, the mean number of hops is approximately [symbol] h [symbol] ≅0.94√(N−1)/ [symbol] δ [symbol] ′. This expression slightly under predicts the correct result in the special case where each node is connected directly to every other node via a dedicated physical link (i.e. δ=N−1 and [symbol] h [symbol] ≡1). Brute force evaluation of the mean number of hops for regular networks of constant degree for δ=3 and δ=4, except for the nodes at the perimeter, yields [symbol] h [symbol] ≅1.2√N/< [symbol] δ [symbol] ′, which slightly over-predicts the means number of hops for the special case of δ=N−1 and [symbol] h [symbol] ≡1.

In order to provide accurate compact analytic expressions for all variables for a wide range of networks, the inventor analyzed the average number of hops of several prototypical networks that were designed to be survivable under all possible single link failures. (Note, the failure of a single link implies the simultaneous failure of all demands appearing on the specified inter-nodal segment, which may be a very large number of demands.) This feature of network survivability translates into the requirement that the degrees of nodes for all nodes be greater than or equal to two (i.e., δ≧2). The exact results for the mean number of hops were fitted using the method of least squares deviation to determine the single coefficient of proportionality that best describes the data for all the networks considered. In total data for 14 mesh networks with numbers of nodes spanning the range 4≦N≦100 and average degree of node spanning the range 2.5≦(δ)≦5 were included. It was determined by the inventor that the expectation value of the number of hops for these networks with uniform demand may be expressed semi-empirically by the relation of equation (14b), which follows: [symbol]
h [symbol] ≅1.12\sqrt{N/δ} (14b)
with a standard deviation of approximately 10 percent, and more accurately by the relation [symbol]
h [symbol] ≅√(N−2)\overline{/( [symbol] δ [symbol] −1)}, (14c)
with a standard deviation of approximately 2 percent.

These approximate formulae may be applied to the case of uniform, location-independent, or random demand. For fixed network topology, it is expected for the average number of hops to decrease for distance dependent demand models that weigh shorter distance demands more heavily than longer distance demands.

The estimate of the mean number of hops for the example network 200 of FIG. 2 having N=100 nodes and L=171 links determined using equation (14c) above is [symbol] h [symbol] ≅6.1, which may be compared to the actual mean of [symbol] h [symbol] =6.6. For the example network having N=25 nodes and L=42 links, the mean number of hops determined using equation (14c) is approximately [symbol] h [symbol] ≅3.0.

The variance of the number of hops may be computed from [h] using equation (13); however, it is not necessary to compute σ²(h) explicitly for the analyses that follow. The range of hops extends from 1 to some maximum number H, which is often referred to as the diameter of the network.

Demands on Link

It is evident that as a demand dᵢⱼ is routed across the network between terminating nodes (i,j) that the demand occupies a unit of transmission capacity on each of the links connecting the nodes. The minimum number of links occupied by a demand is, of course, the minimum number of hops hᵢⱼ from node i to node j. Consequently, the average number of demands carried on a link in the absence of extra capacity for restoration may be characterized according to equations (15a) and (15b), which follow:

$$〈 {W}^{0} 〉 = \frac{1}{L} {\sum }_{i}^{L} {D}_{i} \times 1 = \frac{1}{L} {\sum }_{i , j}^{D} 1 \times {h}_{ij} = \frac{1}{L} \frac{D}{D} {\sum }_{i , j}^{D} {h}_{ij} = \frac{D {〈 h 〉}_{D}}{L} , \qquad ( 15 a )$$

which may be rewritten in the convenient form [symbol]
W⁰ [symbol] = [symbol] d [symbol] [symbol] h [symbol] / [symbol] δ [symbol] (15b)
using equations (11b) and (13b). The expression of equation (15b) is exact and valid and independent of the demand model; however, the value of [symbol] h [symbol] is implicitly dependent upon the demand model, as discussed earlier. In the cases of uniform or random demand, if an approximation for [symbol] h [symbol] such as equations (14b) or (14c), is used to compute [symbol] W⁰ [symbol] , then of course the result is also approximate, and the relative error of [symbol] h [symbol] determines the relative error of [symbol] W⁰ [symbol] .

For uniform demand, the value for [symbol] d [symbol] in equation (15b) may be substituted to obtain equation (15c), which follows: [symbol]
W⁰ [symbol] =(N−1) [symbol] h [symbol] / [symbol] δ [symbol] . (15c)
Using equation (15c), the mean number of channels carried on a link for the first example network 200 of FIG. 2 having N=100 nodes and L=171 links ( [symbol] δ [symbol] =3.4 and [symbol] h [symbol] ≅6.1) is estimated to be [symbol] W⁰ [symbol] ≅178. Similarly, the mean number of channels on a link for the second example network having N=25 nodes and L=42 links ( [symbol] δ [symbol] =3.4 and [symbol] h [symbol] ≅3.0) is estimated to be [symbol] W⁰ [symbol] =22.

As suggested by equation (15b), variations in the number of channels carried on the individual links of the network may arise from differences in the number of demands terminating at the nodes connected to the links, the degrees of the nodes connected to the link, and also the routing constraints and algorithms. Here the case of uniform demand is considered, and the fluctuations that may arise when the demands are routed across the network under the constraint of minimum hop routing are first considered. In general, for any pair of nodes there will be one or more routes of minimum number of hops between the nodes. Consequently, the variation in the number of channels carried on a link will depend upon the selection criteria for choosing from among the set of minimum hop routes, which are referred to by the inventor as hop-degenerate routes. If it is assumed that the path is selected at random from the hop-degenerate routes, then the variance may be estimated using statistical methods. In particular, for the scenario just described, the distribution of the demands among the minimum hop routes is described by the binomial distribution. As such, an approximate expression for the variance of W^{o} is derived by the inventor considering random routing over paths of equal numbers of hops.

Referring back to equations (15a)-(15c) above, the mean value for the number of channels on a link for uniform two-way demand may be explicitly characterized according to equation (15d), which follows:

$$〈 {W}^{0} 〉 = \frac{1}{L} \frac{1}{2} {\sum }_{i}^{N} {\sum }_{j}^{N - 1} {h}_{ij} = N ( N - 1 ) 〈 h 〉 / 2 L . \qquad ( 15 d )$$

For a given node pair (i,j), all the paths of minimum hops hᵢⱼ between them are considered, and lᵢⱼ is used to denote the total number of distinct links among the set of hop-degenerate routes. These distinct links are labeled using the subscript k and pₖ is used to denote the probability that a link is selected. By construction, the set of probabilities {pₖ} satisfies equation (15e), which follows:

$${h}_{ij} = {\sum }_{k}^{{I}_{ij}} {p}_{k} , \qquad ( 15 e )$$

and consequently, pₖ≅hᵢⱼ/lᵢⱼ. As an example, consider an illustrative case when there are three (r=3) link-disjoint routes of four (h=4) (minimum) hops between a pair of nodes. In this case lᵢⱼ=r×h=3×4=12. As the paths are assumed to be disjoint, we may use equation (15e) to solve for pₖ with the result pₖ=hᵢⱼ/lᵢⱼ=h/(rh)=1/r=⅓ for each link.

Substituting equation (15e) into equation (15d) results in equation (15f), which follows:

$$〈 {W}^{0} 〉 = \frac{1}{2 L} {\sum }_{i}^{N} {\sum }_{j}^{N - 1} {\sum }_{k}^{{I}_{ij}} {p}_{k} . \qquad ( 15 f )$$

Using the properties of the binomial distribution, the corresponding variance σ²(Wₒ) may be characterized according to equations (15g) and (15h), which follow:

$${σ}^{2} ( {W}^{0} ) = \frac{1}{2 L} {\sum }_{i}^{N} {\sum }_{j}^{N - 1} {\sum }_{k}^{{I}_{ij}} {p}_{k} ( 1 - {p}_{k} ) , \qquad ( 15 g )$$

using equations (15e) and (15f), equation (15g) may be rewritten as

$${σ}^{2} ( {W}^{0} ) = 〈 {W}^{0} 〉 [ 1 - \frac{1}{N ( N - 1 ) 〈 h 〉} {\sum }_{i}^{N} {\sum }_{j}^{N - 1} {\sum }_{k}^{{I}_{ij}} {p}_{k}^{2} ] . \qquad ( 15 h )$$

To evaluate the sums we next group the sum over the N−1 nodes into sets of constant numbers of hops, h. Let there be Nₕ nodes of h hops, and label each node by the index n. For each node the number of distinct links among the possible routes of h hops is denoted l_{n,h}. If H is the largest value of the set of minimum number of hops, then equation (15h) may be rewritten according to equation (15i), which follows:

$${σ}^{2} ( {W}^{0} ) = 〈 {W}^{0} 〉 [ 1 - \frac{1}{〈 h 〉} \frac{1}{N} {\sum }_{i}^{N} \frac{1}{N - 1} {\sum }_{h}^{H} {\sum }_{n}^{{N}_{h}} {\sum }_{k}^{{I}_{nh}} {p}_{k}^{2} ] . \qquad ( 15 i )$$

The above expression is exact under the assumption of uniform demand and random routing.

To carry this result further, an approximation for a planar network of average degree <δ> is derived. In this case the maximum number of hops H is characterized according to equation (15j), which follows:
N−1= [symbol] δ [symbol] [H(H+1)]/2, (15j)
and the value of H is related to [symbol] h [symbol] by H≅√2 [symbol] h [symbol] .

When focusing on a single node within the network, the nodes that may be reached in h minimum hops are identified as approximately [symbol] δ [symbol] h in number. The options for routing from the node under consideration to each of the other nodes h minimum hops away are subsequently considered. There is at least one possible route and the number of hop-degenerate routes are denoted by the inventor as r. Next, the number of distinct links l_{n,h} among these r hop-degenerate routes are identified and counted. For the planar network, the number of distinct links l_{n,h} is less than h²; the latter being the number in the situation when the hop-degenerate routes are link-disjoint paths. Consequently, the probability any one link is selected when choosing a path randomly from among the hop-degenerate routes of the network is greater than 1/h, which may be characterized according to (15k), which follows:
pₖ≧1/h. (15k)
This expression for the probability that a link is selected permits the formal bounding of the variance of the number of channels. Substituting equation (15k) into equation (15i), carrying out the sums and using equation (15j) yields equations (15l) and (15m), which follow:

$$\begin{matrix}{σ}^{2} ( {W}^{0} ) \leq 〈 {W}^{0} 〉 [ 1 - 1 / 〈 h 〉 ] and & ( 15 l ) \\ \frac{σ ( {W}^{o} )}{〈 {W}^{0} 〉} \leq \sqrt{1 - \frac{1}{〈 h 〉}} / \sqrt{〈 {W}^{0} 〉} \leq \frac{1}{√ 〈 {W}^{0} 〉} & ( 15 m )\end{matrix}$$

The form of the variance in equation (15l) is that of a binomial distribution with probability 1/<h>. Thus, the actual distribution is approximated by the corresponding binomial distribution F(W=w), which is characterized according to equations (15n)-(15q), which follow:
F(W=w)=(wₘₐₓ|w)p^{w}(1−p)^{w}ₘₐₓ^{-w}, w=0, 1, . . . , wₘₐₓ (15n)
with p=1/ [symbol] h [symbol] (15o)
wₘₐₓ≡ [symbol] W⁰ [symbol] [symbol] h [symbol] (15p)
and
(wₘₐₓ|w)=wₘₐₓ!/[w!(wₘₐₓ−w)!]. (15q)
The binomial tail probability F(W≧w) may be determined using the incomplete beta function.

Using Eq. 15l, the standard deviation of the number of channels on a link for the example network 200 of FIG. 2 having N=100 nodes and L=171 links ( [symbol] δ [symbol] =3.4 and [symbol] h [symbol] =6.1) is estimated to be σ(W^{o})≦12. Recall the mean number of channels on a link was estimated to be (W^{o})≅178 for this network. Again using Eq. 15l, the standard deviation of the number of channels on a link for the example network 200 of FIG. 2 having network of N=25 nodes and L=42 links ( [symbol] δ [symbol] =3.4 and [symbol] h [symbol] =3.0) is estimated to be σ [symbol] W^{o} [symbol] ≅3.8. The mean number of channels on a link was estimated to be [symbol] W^{o} [symbol] ≅22 in this case.

In the above consideration of the variation of W^{o}, the inventor recognizes that usually when traffic is routed and the network is optimized, paths are selected based on criteria such as the minimum number of hops, the shortest distance, or more generally the minimum cost. However, routing solutions that may be proven to be optimal are possible only for relatively small networks and, therefore, additional heuristic constraints are often imposed as strategies to ensure low cost. To minimize the cost of survivable networks, for example, algorithms to balance the traffic among the links are often introduced. By its definition, load-balancing deliberately seeks to dampen the variation of the number of channels carried on a link. Clearly if load-balancing is effective then the selection of paths from among the hop-degenerate routes is not random and σ(W^{o}) should be reduced relative to the value specified by equation (15l) above. As a corollary, the ratio of the achieved variance to the value obtained for random routing is a measure of the success of the load-balancing algorithm.

The variance of the number of channels carried on a link derived above is a network global expectation based on routing decisions. A local view of the variations and the number of channels carried on a particular link (i,j) and their relationship to the terminating traffic and degrees of the local nodes may also be considered. A form for Wᵢⱼ based on equation (15b) and an heuristic argument based upon the routed traffic may be developed. Equation (15b) may be written to identify the local traffic terminating at the nodes connected to the link (both ends) and the through traffic that passes by both nodes according to equation (15r), which follows: [symbol]
W^{o} [symbol] =2 [symbol] d [symbol] / [symbol] δ [symbol] + [symbol] d [symbol] ( [symbol] h [symbol] −2)/ [symbol] δ [symbol] . (15r)
The first term corresponds to the division of the terminating traffic among the various links connected to the terminating nodes. Assuming minimum hop routing, to a good approximation the terminating traffic is equally distributed among all the links connected to the node. This implies a direct correlation of the first term of equation (15r) to the local degrees of nodes connected to the link. The second term, however, corresponds to the many channels traversing the link that have destinations distributed across the entire network. For the moment it is considered that the traffic is routed to minimize the number of hops, but otherwise no preference among the individual links is imposed. Under these circumstances it is hypothesized that the second term has negligible correlation to the local degrees of nodes and is best described by a combination of the mean value and variations randomly distributed across the network. Therefore, the number of channels on a link may be characterized according to equations (15s) and (15t), which follow:
Wᵢⱼ=W_{B/E}+W_{B/T} (15s)
with
W_{B/E}≡dᵢ(1/δᵢ+1/δⱼ)−1. (15t)
(The right most “−1” in equation (15t) ensures the proper accounting of the demand between node i and node j.) The variable W_{B/T} includes random variations in the number of through channels and satisfies equation (15u), which follows: [symbol]
W_{B/T} [symbol] ≡ [symbol] d [symbol] ( [symbol] h [symbol] −2)/ [symbol] δ [symbol] +1. (15u)
The variance of W_{B/T} may be estimated using the statistical formalism described above with respect to equation (15l) with W_{B/T} replacing W^{o} and [symbol] W_{B/T} [symbol] replacing [symbol] W^{o} [symbol] .

It can be verified by direct computation that the expectation value of W_{i,j} (equations 15s-15u) yields [symbol] W^{o} [symbol] (equation 15r) in the case of location-independent demand, as required. As the second term of equation 15r is locally uncorrelated with the first term, the variance of W^{o} may therefore be expressed according to equation (15v), which follows:
σ²(W^{o})≅(2/ [symbol] δ [symbol] )²σ²(d)+ [symbol] d [symbol] ²σ²(1/δ)+σ²(W_{W/T}) (15v)
The variance associated with routing decisions implicitly assuming no variation in δ has already been estimated using equation (15l). Now, the relative size of the variance in W^{o} attributable to variations in the degrees of the nodes may also be estimated. The variations correlated to the local degrees of nodes (i.e., the second term of equation (15v)), may be computed directly from the network graph. For the present it should be noted that for uniform demand σ²(d)≡0, and
σ(W_{B/E})/ [symbol] W_{B/E} [symbol] ≅\sqrt{[ [symbol] δ [symbol] ₙ [symbol] 1/δ [symbol] ₙ−1]/2}. (15w)
Using equations (15t) and (15w), the mean and standard deviation of the number of A/D channels terminating at the two ends of a link are estimated to be [symbol] W_{B/E} [symbol] ≅58 and σ(W_{B/E})≦13, respectively, for the example network 200 of FIG. 2 having N=100 nodes and L=171 links ( [symbol] δ [symbol] =3.4, [symbol] h [symbol] ≅6.1, [symbol] 1/δ [symbol] =0.32). The mean number of channels not terminating at either end of a link is approximately [symbol] W_{B/T} [symbol] ≅120 for this network. For the smaller example network having N=25 nodes and L=42 links ( [symbol] δ [symbol] =3.4, [symbol] h [symbol] ≅3.0, [symbol] 1/δ [symbol] =0.32) the mean and standard deviation of the number of A/D channels terminating at the two ends of a link are estimated to be [symbol] W_{B/E} [symbol] ≅14 and σ(W_{B/E})≦2.8. The mean number of channels not terminating at either end of a link is approximately [symbol] W_{B/T} [symbol] ≅7.5 for this example.

If the terminating demands are not uniformly distributed, but instead randomly distributed, then the first term in equation (15v) proportional to σ²(d) (i.e., σ_{d}²(W^{o})) also contributes to the variance of W^{o} according to equation (15x), which follows:
σ_{d}(W^{o})/ [symbol] W^{o} [symbol] =[2/ [symbol] h [symbol] ][(σ(d)/ [symbol] d [symbol] ]. (15x)
As previously stated, the expressions for [symbol] W^{o} [symbol] (equations (15b) and (15c)) are exact and independent of the estimations of σ(Wₒ).
Restoration Capacity

The additional capacity added to links to ensure network survivability depends upon the types of failures considered, the restoration strategy strategy, and the blocking characteristics of the cross-connects used to redirect the affected traffic over alternate routes. For the purpose of architectural comparisons, network survivability is very often defined in relation to single link failures (i.e., the network is designed and minimally sufficient capacity is deployed to ensure the network can support the traffic and is survivable against all single link failures). As explained earlier, this implies the network has sufficient extra capacity to restore all of the simultaneously failed demands sharing the common failed link. Extra capacity is counted in units of additional channel-links and is most often reported as a fractional increase above the total number of channel-links for minimum hop routing. Using that convention, the average number of channels on a link including extra capacity for restoration may be characterized according to equation (16a), which follows: [symbol]
W^{κ} [symbol] ≡ [symbol] W^{o} [symbol] (1+ [symbol] κ [symbol] ). (16a)
The superscript designation κ is introduced to W to indicate that the expression accounts for extra capacity for restoration. This expression is independent of the demand model. In considering the individual failure of all the δi+δj−1 links that are connected to the two nodes at the ends of link (i,j), the number of channels on an individual link (i,j) including the extra capacity for restoration is characterized according to equation (16b), which follows:
W^{κ}ᵢⱼ=Wᵢⱼ+ [symbol] W^{o} [symbol] κᵢⱼ, (16b)
where Wᵢⱼ and [symbol] W^{o} [symbol] are given by equations (15t)-(15v) and equation (15s), respectively. The mean value of this model for W^{κ}ᵢⱼ yields equation (16a), as required. Below formulae are developed for [symbol] κ [symbol] and κᵢⱼ as functions of the input network variables.

Precisely determining the amount of additional capacity requires a detailed network analysis and a non-trivial exercise for large mesh networks. Obtaining exact results for general mesh networks when the number of nodes is more than about 20 is presently not practical because of the magnitude and duration of the numerical computations. Thus, some form of heuristic algorithm for routing traffic and assigning restoration capacity is usually employed for large networks.

In considering the extra capacity that must be deployed to ensure survivability against single link failures, a general inverse dependency upon the degree of the nodes is readily recognized and explained qualitatively. For example, a ring network (which by definition has an average degree of node equal to 2) with dedicated protection requires 100% extra capacity relative to the minimum capacity necessary to carry the traffic demand. As such, a qualitative relationship between the fractional increase in capacity on a link and the degree of the node to which the link is connected may be characterized according to equation (17a), which follows:
κ˜1/(δ−1). (17a)
However, a strict interpretation of equation (17a) as an equality can under-predict by one-third or more the necessary extra capacity for planar mesh networks when [symbol] δ [symbol] is greater than 2. To assess the feasibility of using an analytic equation to model the extra capacity, we have fitted the extra capacity determined by detailed calculation and simulation of mesh networks with uniform demands for the case of strictly non-blocking cross-connects using the expression [symbol]
κ [symbol] =(a−b)/( [symbol] δ [symbol] −b), (17b)
where a and b are parameters to be determined semi-empirically.

The results for the extra capacity for 8 mesh networks are considered and the condition is also imposed that [symbol] κ [symbol] =1 for [symbol] δ [symbol] =2. The mesh networks had numbers of nodes N in the range of 4≦N≦100, average degree of node in the range of 2.5≦ [symbol] δ [symbol] ≦4.5, and required an average extra capacity in the range of 0.4≦ [symbol] κ [symbol] ≦0.9. The constraint to describe the ring network exactly using equation (17b) requires a =2. The best value of b was then determined to be b=−0.4. Within the accuracy (σ≅±17%) of the fitted results, the functional form for the extra capacity may be characterized according to equation (17c), which follows: [symbol]
κ [symbol] ≅2/ [symbol] δ [symbol] . (17c)
The form of equation (17c) for the required extra capacity in the case of single link failures suggests that only one-half of the links connected to a node in common with the failed link participate in carrying the rerouted traffic. This is understood qualitatively when it is considered that using the other one-half of the links would result in diverting the rerouted traffic further away from its intended destination and consequently over even longer paths, which may introduce increased signal impairments, such as longer latency and higher bit-error-rate, as well as the complexity of involving larger numbers of nodes. For completeness an expression is noted for the extra capacity on the individual links that results in the expectation value of the extra capacity given by equation (17c), which is characterized according to equations (17d) and (17e), which follow:

$$\begin{matrix}{κ}_{ij} = \frac{1}{2} [ 2 / {δ}_{j} + 2 / {δ}_{j} ] and & ( 17 d ) \\ 〈 κ 〉 ≡ \frac{1}{L} {\sum }_{i , j}^{L} {κ}_{i , j} ≅ \frac{1}{L} {\sum }_{i , j}^{L} ( \frac{1}{{δ}_{i}} + \frac{1}{{δ}_{j}} ) = \frac{1}{L} {\sum }_{n}^{M} {\sum }_{κ}^{{δ}_{n}} \frac{1}{{δ}_{n}} = \frac{N}{L} = \frac{2}{〈 δ 〉} & ( 17 e )\end{matrix}$$

or more explicitly [symbol] κ [symbol] ₗ=2/ [symbol] δ [symbol] ₙ. It should be noted however, that based on equation (17e), the property that [symbol] 1/δ [symbol] ₗ=1/ [symbol] δ [symbol] ₙ. However, in general, [symbol] 1/δ [symbol] ₙ≠1/ [symbol] δ [symbol] ₙ except for in regular networks of constant degree, δ, or as an approximation.

A slightly more accurate semi-empirical representation (σ≅±12%) of the values of the extra capacities of the networks considered is characterized according to equations (17f) and (17g), which follow: [symbol]
κ [symbol] ₗ= [symbol] 2/δ [symbol] ₙ, (17f)
for which the corresponding local extra capacity is
κᵢⱼ=½[(2/δᵢ)²+(2/δⱼ)²]/[2/ [symbol] δ [symbol] ]. (17g)
In both cases it is clear there is a strong correlation between the efficient use of spare capacity for survivability and the degrees of the nodes. Note too that the success of equations (17c)-(17g) in representing the required extra capacity also reinforces the postulation that the traffic load is relatively balanced on the individual links (i.e., equation (15b). It is also expected that the approximate analytic expressions for κ (e.g., equations (17)) hold independent of the demand model, as they were hypothesized based on the mesh topology of the network, and not explicitly upon the demand model. Finally, it is pointed out that the additional capacity required for dynamic networks, such as for survivable networks, will be larger if the cross-connects are not strictly non-blocking. For example, in the case of wavelength-division-multiplexed line systems and cross-connects without wavelength interchange except at the terminations, the increase of the extra capacity for restoration above the minimum value for strictly non-blocking cross-connects is typically in the range of only 5-20%, although the management complexity is greatly increased.

For the example network 200 of FIG. 2 having N=100 nodes and L=171 links ( [symbol] δ [symbol] =3.4), the mean value of the extra capacity to ensure survivability under single link failures is estimated to be [symbol] κ [symbol] ≅0.58. As the mean degree of node for the second example network having N=25 nodes and L=42 links is nearly identical to that of the larger network by design, [symbol] δ [symbol] ≅3.4, the estimate for the mean value of the extra capacity to ensure survivability under single link failures is also nearly the same at [symbol] κ [symbol] ≅0.60.

As described above, the extra capacity on individual links has been modeled in a manner that is both intuitive and consistent with empirical observations of the total extra capacity. The model for {κ} depends only upon the degrees of the nodes, {δ}, and consequently it is a function of the input network graph G, as stated explicitly in equation (13a).

Traffic on Link

The average traffic carried on a link [symbol] β [symbol] is the product of the average number of demands on a link [symbol] W [symbol] and the termination-to-termination traffic per demand τ, and is characterized according to equation (18a), which follows: [symbol]
β [symbol] ≡ [symbol] W [symbol] τ=τ [symbol] h [symbol] D/L= [symbol] h [symbol] T/L. (18a)
This direct proportionality is independent of the demand model.

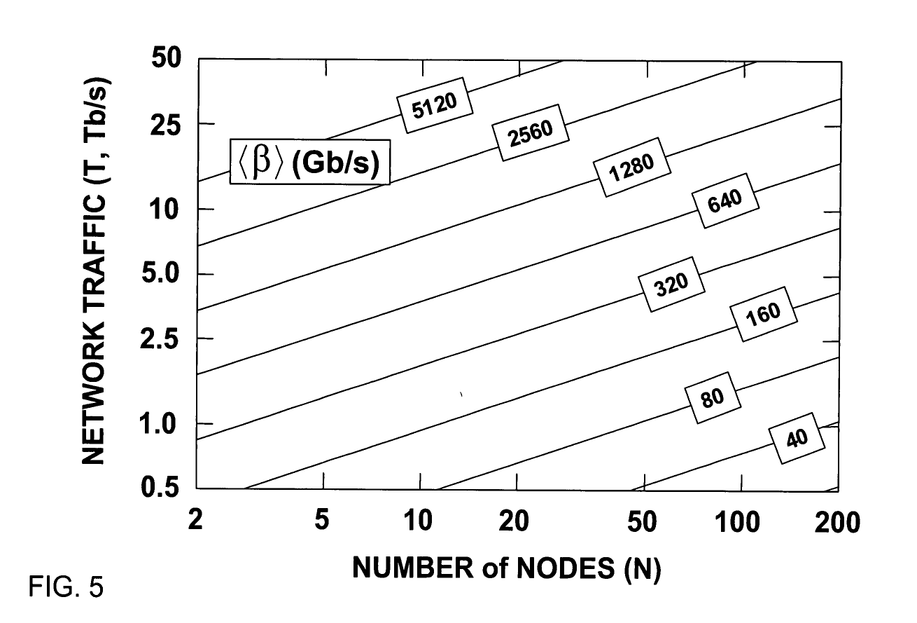

FIG. 5 graphically depicts a plot of the mean traffic on a link including idle restoration channels for uniform demand as a function of the number of nodes N and total network traffic T. In FIG. 5, the mean traffic on a link [symbol] β^{κ}(N, T) [symbol] for uniform demand with restoration is graphed as a function of the number of nodes N and total two-way traffic under the constraint [symbol] δ [symbol] =3.5 using a contour plot.

For the example network 200 of FIG. 2 having N=100 nodes, L=171 links, and T=5 Tb/s, the mean value of the traffic carried on a link including extra capacity for restoration is [symbol] β^{κ} [symbol] ≅284 Gb/s. In comparison, the mean value of the traffic carried on a link including extra capacity for restoration for the smaller example network having N=25 nodes, L=42 links, and T=1 Tb/s, is [symbol] β^{κ} [symbol] ≅16 Gb/s.

Based on the preceding discussions, the inventor determined that the variance of β is determined by the variance of W and that the variances are related according to equation (18b), which follows:
σ(β)/ [symbol] β [symbol] =σ(W)/ [symbol] W [symbol] . (18b)
Number of Ports and Capacity of a Cross-Connect

Among the key attributes of cross-connects are the port count, P, and total capacity, χ. The average number of ports on a cross-connect in a mesh network can be determined by counting the number of ports that each demand occupies as it traverses the network, tallying the number of ports for all demands, and then dividing by the number of cross-connects. By design a cross-connect—of which an add-drop multiplexer is considered a special case—is placed at each node of the backbone network to manage transport bandwidth, and so the number of cross-connects is given by the number of nodes, N.

As illustrated in FIG. 3, the number of output ports is usually equal to the number of inputs. Also, a P×P cross-connect, which has P inputs and P outputs (or P I/O ports), supports connections among P two-way channels.

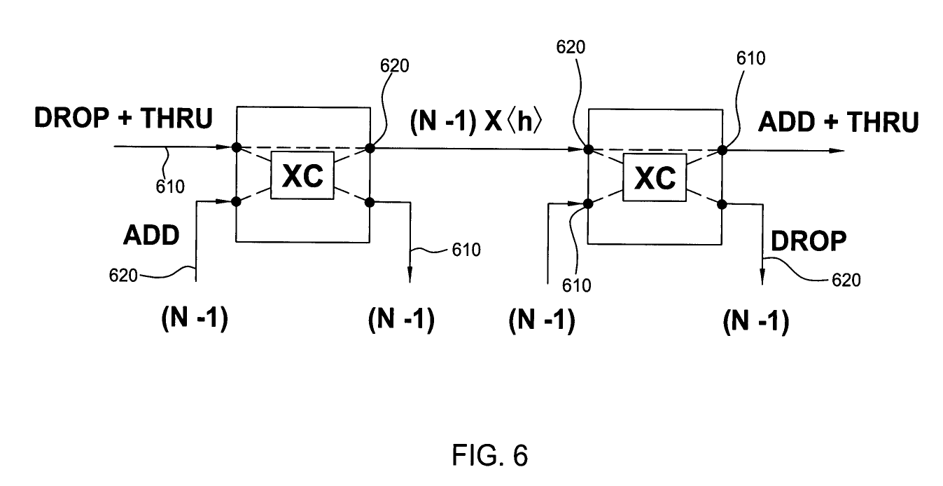

The average number of one-way input ports, P₁ is first calculated. FIG. 6 depicts a high level block diagram of two cross-connect ports 610, 620 and the relationship among the local ADD, DROP and THRU channels. FIG. 6 illustratively serves as a guide to counting the number of cross-connect ports occupied by a demand as it traverses a network. In FIG. 6, the numbers of add and drop demands, depicted as N−1, specifically correspond to the uniform demand model. Referring to FIG. 6, consider a directed demand that enters, or is added to, the network via the cross-connect of the node on the left. Adding the demand requires one input port. Eventually, this demand exits the network. Dropping from the network is accomplished by entering and exiting the cross-connect at the destination node, which may be considered the node on the right of FIG. 6. Thus, dropping the demand also requires one input port. Additionally, in traversing the network the demand under consideration occupies input ports at the cross-connects of the intervening nodes. Having defined “h” as the number of inter-terminal hops, the number of intervening cross-connects that the demand enters is h−1. Consequently, the number of input ports that a one-way demand occupies may be characterized according to equation (19a), which follows:
pᵢⱼ=1+1+(hᵢⱼ−1)=1+hᵢⱼ. (19a)
The total number of input ports occupied by all demands is therefore characterized according to equation (19b), which follows:

$${P}_{t} = {\sum }_{i , j}^{{D}_{1}} [ 1 + {h}_{i , j} ] = \frac{{D}_{1}}{{D}_{1}} {\sum }_{i , j}^{{D}_{1}} [ 1 + {h}_{i , j} ] = {D}_{1} 〈 1 + {h}_{i , j} 〉 = N 〈 d 〉 [ 1 + 〈 h 〉 ] , \qquad ( 19 b )$$

and the average number of input ports [symbol] P₁ [symbol] occupied on a cross-connect at a node is characterized according to equation (19c), which follows: [symbol]
P₁ [symbol] =(D₁/N)[1+ [symbol] h [symbol] ]= [symbol] d [symbol] [1+ [symbol] h [symbol] ]. (19c)
Equations (19a)-(19c) are valid independent of the demand model; while as before the value of [symbol] h [symbol] is implicitly dependent upon the demand model. For the case of a mesh network with uniform demands, [symbol] d [symbol] in equation (19c) is substituted using equation (11c) to obtain equation (19d), which follows: [symbol]
P₁ [symbol] =(N−1)[1+ [symbol] h [symbol] ], (19d)
where [symbol] h [symbol] may be approximated using equation (14b) or equation (14c).

For completeness, the average number of two-way ports for a cross-connect of the same network is computed. The number of two-way terminations for a two-way demand is 2, one at each terminus. The average number of two-way thru ports occupied is 2[1+ [symbol] h [symbol] ] and the total number of two-way ports occupied is characterized according to equation (19e), which follows:

$${P}_{t} = {\sum }_{i < j}^{{D}_{2}} [ 1 + {h}_{i , j} ] = \frac{{D}_{2}}{{D}_{2}} {\sum 2}_{i < j}^{{D}_{2}} [ 1 + {h}_{i , j} ] = 2 {D}_{2} 〈 1 + {h}_{i , j} 〉 = 2 {D}_{2} [ 1 + 〈 h 〉 ] . \qquad ( 19 e )$$

Thus, the average number of two-way ports is characterized according to equation (19f), which follows: [symbol]
P₂ [symbol] =2(D₂/N)[1+ [symbol] h [symbol] ]. (19f)
By substituting for D₂ using equation (10c), the inventor has determined equation (20a), which follows: [symbol]
P [symbol] ≡ [symbol] P₂ [symbol] = [symbol] P₁ [symbol] , (20a)
which may be appreciated by again considering FIG. 3. This result is independent of the demand model and may also be structured to explicitly indicate the add, drop and through ports. Considering FIG. 6 and equation (20a) above, the inventor proposes equation (20b), which follows: [symbol]
P [symbol] ≡ [symbol] P_{ADD} [symbol] + [symbol] P_{DROP} [symbol] + [symbol] P_{THRU} [symbol] (20b)
where [symbol]
P_{ADD} [symbol] = [symbol] P_{DROP} [symbol] = [symbol] d [symbol] (20c)
and [symbol]
P_{THRU} [symbol] = [symbol] d [symbol] ( [symbol] h−1) (20d)
and as such, [symbol]
P_{ADD} [symbol] + [symbol] P_{DROP} [symbol] =2 [symbol] d [symbol] . (20e)
As previously stated, every demand occupies both a termination-side port and line-side port on each of the two cross-connects at the opposite ends of the demand. Another common partitioning of ports is between termination-side ports and line-side ports. In this case equation (20b) is rewritten according to equation (20f), which follows: [symbol]
P [symbol] ≡ [symbol] P_{TERM} [symbol] + [symbol] P_{LINE} [symbol] (20f)
where [symbol]
P_{TERM} [symbol] = [symbol] P_{ADD} [symbol] = [symbol] d [symbol] (20g)
and [symbol]
P_{LINE} [symbol] = [symbol] P_{DROP} [symbol] + [symbol] P_{THRU} [symbol] = [symbol] d [symbol] [symbol] h [symbol] . (20h)

In the above analysis for the average number of ports, the extra transmission capacity and extra cross-connect ports that are required for network survivability were introduced. As discussed earlier, for single-link failure scenarios, the link or line-side capacity is increased by the fraction <κ>. Thus, the total number of cross-connect ports for shared line-side restoration of mesh networks is obtained by introducing the extra capacity factor into equations (20h) and (19c), which results in equation (21 a), which follows: [symbol]
P^{κ} [symbol] = [symbol] d [symbol] [1+(1+ [symbol] κ [symbol] ) [symbol] h [symbol] ]. (21 a)
The same result is also obtained considering that the total number of ports is the sum of the number of channels carried on each of the links connected to the node and the number of channels terminating at the node. The former is given by the product of W^{o} and δ, and therefore yields equation (21b), which follows: [symbol]
P^{κ} [symbol] = [symbol] d [symbol] + [symbol] W^{o} [symbol] (1+ [symbol] κ [symbol] ) [symbol] δ [symbol] . (21b)
Using equations (13b) and (15b) and the definition of [symbol] κ [symbol] it can be determined and illustrated that equation (21b) equates to equation (21a).

To appreciate how [symbol] P [symbol] scales with the number of nodes, equations (21) may be considered for uniform traffic in the limit when N is large compared to 1. In that limit and using equations (11c), (14c) and (17c) for [symbol] d [symbol] , [symbol] h [symbol] and [symbol] κ [symbol] , respectively, equation (21b) may be rewritten according to equation (22a), which follows: [symbol]
P^{κ} [symbol] ≈[(1+2/ [symbol] δ [symbol] )/√ [symbol] δ [symbol] ]N^{3/2}. (22a)
For networks with [symbol] δ [symbol] in the range of 3≦ [symbol] δ [symbol] ≦4, the term in equation (21b) dependent upon [symbol] δ [symbol] is within 14% of unity and for [symbol] δ [symbol] =3.5, the coefficient differs from 1 by less than 5%. Consequently, equation (22a) may be rewritten according to equation (22b), which follows: [symbol]
P^{κ} [symbol] N^{3/2}. (22b)
Thus, if the number of nodes in the network is approximately 24, then the average number of ports required is about 125. When N is about 100, then [symbol] P^{κ} [symbol] ˜3000. Similarly, the average traffic cross-section carried on the route between adjacent nodes is characterized according to equation (23), which follows: [symbol]
W^{κ} [symbol] ≈N^{3/2}/ [symbol] δ [symbol] (23)
when N is large compared to unity.

The average traffic handled by a cross-connect [symbol] χ [symbol] , measured in bits/second for example, is now computed straightforwardly from the average number of ports [symbol] P [symbol] and the communication bandwidth, either τ or B, associated with the basic unit of demand. Of course the former corresponds to the case when the channel utilization is 100% and the latter may correspond to a particular system increment or industry standard. Thus the average traffic handled by a cross-connect [symbol] χ [symbol] may be characterized according to equation (24a), which follows: [symbol]
χ(τ) [symbol] ≡ [symbol] P [symbol] τ (24a)
or [symbol]
χ(B) [symbol] >≡ [symbol] P [symbol] B. (24b)
These direct proportionalities are independent of the demand model.

For the example network 200 of FIG. 2 having N=100 nodes and L=171 links, the mean number of ports on a cross-connect including ports for restoration is estimated to be [symbol] P^{κ} [symbol] ≅1061. The corresponding mean cross-connect traffic is 1072 Gb/s. For the smaller example network having N=25 nodes and L=42 links, the mean number of ports on a cross-connect including ports for restoration is estimated to be [symbol] P^{κ} [symbol] ≅141. The corresponding mean cross-connect traffic is 469 Gb/s.

To compute the variance of the number of ports, P, the number of ports required for the individual nodes must be determined. In the preceding sections, expressions for the number of channels on the individual links have been formulated; namely equations (15d-15g), equation (16b), and equation (17d). Consequently, it is necessary only to add the termination side channels to the sum of the channels on the δᵢ links connected to an individual node i to obtain the sum of the ports, P^{κ}ᵢ. Such an expression may be characterized according to equation (25a), which follows:

$${P}_{i}^{κ} = {d}_{i} + {\sum }_{j}^{{δ}_{i}} {W}_{ij}^{κ} . \qquad ( 25 a )$$

Hence, the variance of P^{κ} may be computed using this expression and the definition of the variance, equation (13d). In the spirit of clarifying the dependencies of the variance of P^{κ}, the following illustrates an example where the local extra capacity for restoration is specified by equation (17d). In this scenario the number of ports on a local cross-connect is characterized according to equation (26a), which follows:
P^{κ}ᵢ≅2dᵢ+[dᵢ/ [symbol] δ [symbol] +W_{B/T}+ [symbol] W^{o} [symbol] / [symbol] δ [symbol] ]δᵢ+ [symbol] W^{o} [symbol] , (26a)
where for the total extra capacity associated with ports at node i, the approximation in equation (26b), which follows, was used:

$${κ}_{i} = {\sum }_{j}^{{δ}_{i}} {κ}_{ij} ≅ 1 + \frac{{δ}_{i}}{〈 δ 〉} . \qquad ( 26 b )$$

Considering equation (26a), it is observed that there is a correlation between P^{κ}ᵢ and δᵢ that is moderated by the variations in W_{T}. The variance of P^{κ} for uniform demand is characterized according to equation (27a), which follows:
σ² (P^{κ})≅[ [symbol] d [symbol] / [symbol] δ [symbol] + [symbol] W_{B/T} [symbol] + [symbol] W^{o} [symbol] / [symbol] δ [symbol] ]²σ²(δ)+ [symbol] δ [symbol] ²σ²(W_{T}) (27a)
and the total number of ports, P^{κ} is characterized according to equation (27b), which follows:
P^{κ}ᵢ≅2dᵢ+[dᵢ/ [symbol] δ [symbol] +W_{B/T}]δᵢ+ [symbol] W^{o} [symbol] [symbol] δ [symbol] /δᵢ+ [symbol] W^{o} [symbol] [symbol] δ [symbol] [symbol] 1/δ [symbol] . (27b)
In this case there is a contribution to the number of ports from the extra capacity (1/δᵢ) that is anti-correlated with the main term that is proportional to δᵢ. Thus, it is expected that the variance of P^{κ} in this scenario for the extra capacity, equation (17g), to be somewhat less than the variance obtained using the first form, equation (17d). To illustrate this behavior it was assumed that the variance of W_{T} is small and may be neglected. In this situation the standard deviation for the number ports for both scenarios (equations (17d) and (17g)) for the extra restoration capacity on a link for uniform demand may be characterized according to equations (28a) and (28b), respectively, which follow:
σ(P^{κ})= [symbol] W^{o} [symbol] (1+2/ [symbol] δ [symbol] )σ(δ) (28a)
and
σ(P^{κ})= [symbol] W^{o} [symbol] σ(δ) (28b)
It is evident from the equations above that the standard deviation corresponding to the second form of the local extra capacity, which more strongly varies with the local degree of the node, is smaller by a factor of 1/(1+2/ [symbol] δ [symbol] ). This is understood considering that nodes with smaller degree require larger extra capacity on connecting links and nodes with larger degree require less extra capacity on connecting links. As a result of this anti-correlation the distribution of the required ports is narrowed.

For the example network 200 of FIG. 2 having N=100 nodes and L=171 links the mean and standard deviation of the degree of nodes is [symbol] δ [symbol] =3.4 and σ(δ)=1.1. Consequently, the standard deviation of the number of ports on a cross-connect based on the variance of the degrees of nodes is estimated to be σ(P^{κ})≅307 and σ(P^{κ})≅194 using equation (28a) and equation (28b), respectively. Recall the mean number of ports including restoration capacity was estimated to be [symbol] P^{κ} [symbol] ≅1061. It is expected that the fractional deviations for the smaller example network having N=25 Nodes and L=42 links will be similar, as the statistics of the degrees of nodes are nearly the same by design. Again using equation (28a) and equation (28b), the standard deviation of the number of ports on a cross-connect for this smaller network is estimated to be σ(P^{κ})≅38 and σ(P^{κ})≅24, respectively. Recall that the mean number of ports including restoration capacity was estimated to be (P^{κ})≅141.

In summary, in this and the preceding section it has been shown that the network global expectation model may be used to understand and predict the mean and variability of the number channels carried on links and present at the nodes, including the effects resulting from network survivability. It will be appreciate by one skilled in the relevant art informed by the teachings of the presenting invention that although the model has been illustratively applied to the case of uniform, location-independent, or random demand in this section on the variance of the number of ports, the methodology is directly applicable to other demand profiles.

Percentage Add/Drop

Another important characteristic of the network is the percentage of add and drop traffic at a node. Referring to FIG. 6 and the one-way input ports on the cross-connect, it is observed that the average number of input ports occupied by traffic being either added or dropped at the node may be characterized according to equation (29a), which follows: [symbol]
P_{ADD} [symbol] + [symbol] P_{DROP} [symbol] =D₁/N+D₁/N=2D₁/N (29a)
The average number input ports occupied by traffic passing through the node may be characterized according to equation (29b), which follows: [symbol]
P_{THRU} [symbol] =D₁( [symbol] h [symbol] −1)/N. (29b)
By definition the average ratio of the number of local add/drop ports to local total ports may be characterized according to equation (30a), which follows:

$$〈 ρ 〉 ≡ \frac{1}{N} {\sum }_{n}^{N} {( {P}_{ADD} + {P}_{DROP} )}_{n} / {P}_{n} , \qquad ( 30 a )$$

which may be computed by substituting expressions for both the numerator and the denominator. However, another practical and useful definition of the add/drop ratio average is the ratio of the network total number of add/drop ports to network total ports. In this second case the ratio may be characterized according to equation (30b), which follows: [symbol]
ρ′ [symbol] =N( [symbol] P_{ADD} [symbol] + [symbol] P_{DROP} [symbol] )/N( [symbol] P_{ADD} [symbol] + [symbol] P_{DROP} [symbol] + [symbol] P_{THRU} [symbol] )=( [symbol] P_{ADD} [symbol] + [symbol] P_{DROP} [symbol] )/ [symbol] P [symbol] (30b)
and therefore [symbol]
ρ′ [symbol] =2/[1+ [symbol] h [symbol] ]. (30c)
It should be noted that this relationship between [symbol] ρ′ [symbol] and [symbol] h [symbol] has been derived without reference to a model for the demands D₁. Consequently, it is a general result and not restricted to the case of uniform demands.

If the extra capacity for line-side restoration is accounted for, then the ratio average, [symbol] ρ′^{κ} [symbol] , of the number of add/drop ports to total ports (equations 21) may be characterized according to equation (30d), which follows: [symbol]
ρ′^{κ} [symbol] =2/[1+(1+ [symbol] κ [symbol] ) [symbol] h [symbol] ]. (30d)
The estimated add/drop ratios for the example network 200 of FIG. 2 having N=100 nodes and L=171 links without and with extra capacity for restoration are [symbol] ρ [symbol] ≅0.28 and [symbol] ρ′^{κ} [symbol] =0.19 using equation (30c) and equation (30d), respectively. In comparison, the estimated add/drop ratios for the example network having N=25 nodes and L=42 links without and with extra capacity for restoration are [symbol] ρ′ [symbol] ≅0.49 through [symbol] ρ′^{κ} [symbol] ≅0.34 using equation (30c) and equation (30d), respectively. This trend of increasing the fraction of through traffic as the number of nodes is increased is a general characteristic of a single-tier network with uniform demand. In the limit when N is large compared to 1 and the average degree of node is in the range 3≦ [symbol] δ [symbol] ≦4 the total number of ports is given by equation (22b) and the add/drop ratio average may be characterized according to equation (30e), which follows: [symbol]
ρ′^{κ} [symbol] ≈2/√N. (30e)
Thus, for a mesh network of 25 nodes with shared line-side protection the ratio of add/drop to through channels is approximately 40% on average, and the percentage decreases as the number of nodes increases. Of course, this estimate is for the average node, and the percentage for a particular node can be larger or smaller depending upon the details of the network demand and topology. The use of shared termination-side protection will tend to increase the add/drop ratio.

On a separate note related to the add/drop ratio, it is also worth pointing out that equation (30c) may be inverted to express [symbol] h [symbol] as a function of [symbol] ρ′ [symbol] , according to equation (31), which follows: [symbol]
h [symbol] =[2/ [symbol] ρ′ [symbol] −1]. (31)
Like equation (30c), equation (31) is a general result and not a function of the demand model.

The ratio of the add/drop traffic to total traffic for an individual note may be formulated using equations (25) and (29a). For example, considering the case when σ(W_{T}) is negligible, the result using equation (17d) for the extra capacity may be characterized according to equation (32a), which follows:

$${ρ}_{i}^{κ} = \frac{2 〈 d 〉}{{P}_{i}^{κ}} = \frac{2}{1 + ( 1 + \frac{2}{〈 δ 〉} ) \sqrt{\frac{〈 d 〉}{δ}} \frac{{δ}_{i}}{〈 d 〉}} . \qquad ( 32 a )$$

When N is large compared to 1 and [symbol] δ [symbol] is in the range of 3≦ [symbol] δ [symbol] ≦4, equation (32a) may be approximated according to equation (32b), which follows:
ρ^{κ}ₗ≈(2/√N)[ [symbol] δ [symbol] ^{3/2}/(1+2/ [symbol] δ [symbol] )](1/δᵢ) (32b)
and so in this case
σ(ρ^{κ})/ [symbol] ρ^{κ} [symbol] ≈σ(1/δ)/ [symbol] 1/δ [symbol] . (32c)
Also,
ρ^{κ}_{min/max}/ [symbol] ρ^{κ} [symbol] ≈ [symbol] δ [symbol] /δ_{max/min} (32d)
Thus, given that δᵢ may range from 2 to 8, it may be concluded that the add/drop ratio can conceivably range from ½ to 2 times the mean value.
Network Cost

In the previous section expectation values have been derived for the quantities of key network elements and network element subsystems required to carry out a basic cost analysis for a transport network. In this section the concept of the cost structure of network elements in relation to both the network elements and network element subsystems will be introduced. With an assumed cost structure, the total cost of the network as well as categories of costs may be computed, such as for transmission and bandwidth management. It is also illustrated by example how the network costs are compared using different combinations of technology, such as electronic and optical bandwidth management, using the network global expectation model.

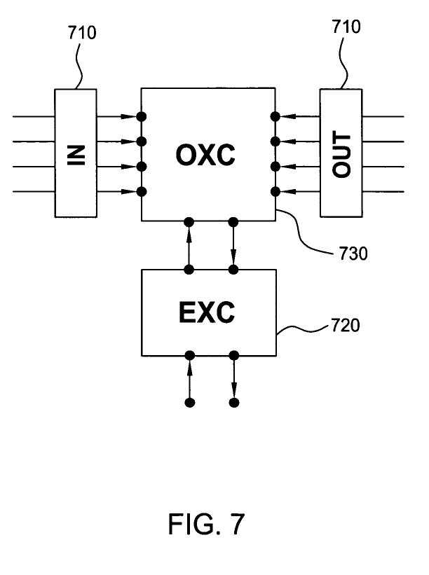

For the purpose of outlining the general principles of computing network costs using the network global expectation model, rudimentary cost structures are considered for the optical line system (OLS), electronic and cross-connect (EXC), and optical cross-connect (OXC). FIG. 7 depicts a high level block diagram of an exemplary architecture of OLS 710, EXC 720, and OXC 730 systems from a perspective near a node. In FIG. 7, termination-side traffic enters the network at a node Via the EXC 720 where it is groomed (i.e., switched and multiplexed, into the fundamental units of inter-terminal bandwidth destined for specific nodes of the network). The groomed output channels from the EXC 720 then enter the OXC 730, where they are directed to line systems placed along the inter-terminal links of the network according to the traffic routing scheme determined by either a centralized or distributed management system. In the architecture considered in FIG. 7, the interfaces between network elements are illustratively optical translators (OTs), which ensure that the cost comparisons are under conditions of fixed network capability (features) and network performance.

Transmission Cost Structure

A cost structure often used for optical fiber transmission is the average cost of transporting bandwidth (B) over distance (s). Herein this cost structure is represented as a cost coefficient, which is denoted as γ_{B-s}. The units of γ_{B-s} are dollars per gigabit per second per kilometer ($/Gbps/km). According to Gawrys, an approximate value for network transmission cost of a two-way channel may be characterized according to equation (33), which follows:
γ_{B-s}≈$30/Gbps/km (33)
based on historical data and projections.

Considering this cost structure, the individual and mean cost of a transmission link of a survivable mesh network may be characterized according to equations (34a) and (34b), respectively, which follow:
Cᵢ=γ_{B-s}βsᵢ, (34a)
and [symbol]
c₁ [symbol] =γ_{B-s} [symbol] βs [symbol] ≅γ_{B-s} [symbol] β [symbol] [symbol] s [symbol] , (34b)
where for the model of uniform demand under present consideration [symbol] β [symbol] is given by equation (16) with [symbol] κ [symbol] given by equation (17c) and [symbol] s [symbol] is the expectation value of the link length. The expectation value of the link length, [symbol] s [symbol] , may be characterized according to equation (35a), which follows:

$$〈 s 〉 = \frac{1}{L} {\sum }_{l}^{L} {s}_{l} , \qquad ( 35 a )$$

where the set {s} are the physical lengths of the individual links. If the link lengths are known, then the expectation value [symbol] s [symbol] is quickly computed. Here, for the purposes of illustration, without introducing a specific set of link lengths, it is noted that for two-dimensional mesh networks the average link length scales inversely with the square-root of the number of nodes and is proportional to the square-root of the geographic area covered by the network. Thus, the expectation value of the link length, [symbol] s [symbol] , may be characterized according to equation (35b), which follows: [symbol]
s [symbol] ≅√A/(√N−1). (35b)
The total cost of transmission is characterized according to equation (36a), which follows:
C_{TRANS}=L [symbol] c₁ [symbol] . (36a)
wherein it should be clear that C_{TRANS} is an analytic function of only the independent input network variables (N, the number of nodes; L, the number of links; T, the total ingress/egress traffic; and A, the geographic area covered by the network), and so is easily computed. Consequently, when N is large compared to 1 and [symbol] δ [symbol] is in the range of 3≦ [symbol] δ [symbol] 4, C_{TRANS} may be approximated according to equation (36b), which follows:
C_{TRANS}≈γ_{B-s}T√A. (36b)

Currently, the yearly time averaged traffic carried by a combined voice and data backbone network in the continental United States is approximately 1 Tb/s. the daily and annual peak traffic load that the network must support is estimated to be ˜5× the average traffic. Thus, as an example we consider T=5 Tb/s. The geographic area of the continental U.S. is approximately A=8×10⁶ km². Thus, the approximate cost of transmission system equipment C_{TRANS} to support the present traffic is approximately $400M.

The approximate cost of transmission represented by equation (36b) is obviously an over simplification as it contains no dependency on the number of links. That behavior is not because of a shortcoming of the global network expectation model, but rather is attributed to our assumption of the cost structure, equations (33) and (34). Clearly a more realistic model of the cost structure for the link should include an explicit dependency upon the cost of optical fiber cable, the cost of end terminals, the cost of OTs, the cost of amplifiers, and the cost of amplifier pumps, for example. Realizing this, a refined cost structure for a link is characterized according to equation (37a), which follows:
cᵢ=γₜ₀+γₜ₁τWᵢ+γₜ₂sᵢ+γₜ₃τWᵢsᵢ. (37a)
The expectation value for the cost of a link may then be characterized according to equation (37b), which follows:

$$〈 {c}_{1} 〉 = \frac{1}{L} {{\sum }_{i}}^{L} {c}_{i} = \frac{1}{L} {{\sum }_{i}}^{L} \{ {γ}_{t0} + {γ}_{t1} τ {W}_{i} + {γ}_{t2} {s}_{i} + {γ}_{t3} τ {W}_{i} {s}_{i} \} , \qquad ( 37 b )$$

where the first term containing γₜ₀ reflects fixed costs for a link, such as the cost of the terminal equipment bays; the second term containing γₜ₁ includes costs that depend directly upon the number of channels carried, such as the number of OTs, the third term containing γₜ₂ includes costs that depend upon the distance traversed, such as the cost of trenching, cost of fiber, and the cost of amplifiers; and the fourth term containing γₜ₃ includes contributions that grow as the product of distance and wavelength, such as the cost of growth pumps and premium for specialized high capacity, long-distance fiber (e.g., dispersion-managed cable).

The total cost of transmission may then be characterized according to equation (37c), which follows:
C_{TRANS}=L [symbol] c₁ [symbol] =L{γₜ₀+γₜ₁τ [symbol] W [symbol] +γₜ₂ [symbol] s [symbol] +γₜ₃τ [symbol] Wₛ [symbol] }. (37c)
Of the expectation values contained in equations (37), all have been previously computed except for [symbol] Wₛ [symbol] . As previously described, the number of channels on a link for the case of uniform demands is nearly independent of the particular link. Thus, [symbol] Wₛ [symbol] = [symbol] W [symbol] [symbol] s [symbol] and the total cost of transmission may be characterized according to equation (37d), which follows:
C_{TRANS}≅L {γₜ₀+γₜ₁τ [symbol] W [symbol] +γₜ₂ [symbol] s [symbol] +γₜ₃τ [symbol] W [symbol] [symbol] s [symbol] }. (37d)
The above approximation is further validated when it is considered that under real world circumstances the coefficient γₜ₃ is small compared to the other coefficients and rarely are the optical line systems loaded to their maximum channel carrying capacity. In this case, to gain a better appreciation for how the total transmission cost depends upon the basic network variables, the last term is dropped. Upon substituting for the remaining expectation values in equation (37d), the cost of transmission may then be characterized according to equation (37e), which follows:
C_{TRANS}(N, T)≅½[γₜ₀+γₜ₂ [symbol] δ [symbol] N√A/(√N−1)+γₜ₁[√A(1+2)/ [symbol] δ [symbol] )/\sqrt{ [symbol]δ [symbol] −1]}T. (37e)
Here, the fixed startup costs (i.e., those independent of the traffic carried T) are evident in the first term, which is proportional to N or L (L=N<δ>/2,equation (13b)).
Bandwidth Management Architectures and Cost Structure
Electronic Bandwidth Management Only

The network global expectation model provides the flexibility and ease of implementation to compute the network element variables and total network costs for a wide range of network sizes, total traffic, and a variety of architectural options. Herein it is illustrated how the costs for two different models of bandwidth management at the network nodes may be constructed. First considered is the case when an electronic cross-connect is used for both sub-rate grooming and cross-connect functions. In this case the total cost of bandwidth management is the cost of the electronic cross-connect, as is characterized in equation (38), which follows:
C_{BWM}=C_{EXC}. (38)
The total cost of the electronic cross-connects may be written in terms of the expectation value of the cost of the nodes according to equation (39a), which follows:
C_{EXC}= [symbol] C_{EXC} [symbol] N, (39a)
which follows directly from equation (8). An estimate of the current cost of high-speed electronic switching engines may be characterized according to equation (39b), which follows:
γₑₚ≈$1K/Gbps, (39b)
which corresponds to a cost structure of the local EXC characterized according to equation (39c), which follows:
C_{EXC}=γₑₚχ(τ). (39c)
Making use of equation (24a), the corresponding expectation value may be characterized according to equation (39d), which follows: [symbol]
c_{EXC} [symbol] =γₑₚ [symbol] χ(τ) [symbol] =γₑₚτ [symbol] P [symbol] . (39d)
Substituting for [symbol] c_{EXC} [symbol] in equation (39a) and using equations (12a) and (21a), the value of C_{EXC} may be characterized according to equation (39e), which follows:
C_{EXC}= [symbol] c_{EXC} [symbol] N=2γₑₚT[(2+ [symbol] κ [symbol] ) [symbol] h [symbol] ]. (39e)
A more refined form for the cost structure of the electronic cross-connect, or IP router, that includes a startup term and a growth term may also be constructed according to equation (39f), which follows:
c_{EXC}=γₑ₀+γₑ₁χ_{τ}. (39f)
In this case
C_{EXC}(N,T)= [symbol] c_{EXC} [symbol] N=γₑ₀N+2[(2+ [symbol] κ [symbol] ) [symbol] h [symbol] ]γₑ₁T. (39g)
These expressions for costs are valid independent of the demand model.
Electronic and Optical Bandwidth Management

Here a single-tier model using both optical and electronic bandwidth management is considered. More specifically, all traffic passes through the optical layer cross-connect and additionally all terminating traffic also passes through an electronic fabric for the purpose of channel grooming. Such an architecture is attractive when the cost of an optical port is significantly less than the cost of an electronic port for a given data rate. The total cost for BWM is thus characterized according to equation (40), which follows:
C_{BWM}=C_{EXC}+C_{OXC} (40)
Cost of Electronic Ports for Termination-Side Traffic

As before, it is assumed that the cost of the electronic switch consists of a startup term and a term proportional to the traffic handled. However, herein only the terminating traffic traverses the EXC. Thus the mean cost of an EXC is characterized according to equations (41a)-(41c), which follow: [symbol]
c_{EXC} [symbol] =γₑ₀+γₑ₁τ [symbol] P_{ADD}+P_{DROP} [symbol] =γₑ₀+γₑ₁2τ [symbol] P_{ADD} [symbol] , (41a)
which, using equation (12) for τ, may be rewritten as [symbol]
c_{EXC} [symbol] =γₑ₀+4γₑ₁T/N. (41b)
Consequently, [symbol]
C_{EXC} [symbol] =γₑ₀N+4γₑ₁T. (41c)
Cost of Optical Ports for Thru and Add/Drop Traffic

The total cost of OXCs using the network global expectation formalism may be characterized according to equation (42a), which follows:
C_{OXC}= [symbol] c_{OXC} [symbol] N. (42a)
An estimate of the current cost of high-speed optical switching engines may be characterized according to equation (42b), which follows:
γₒₚ≈$2.5K/port. (42b)
Based on this cost structure and the architecture under consideration, which specifies that both through and termination-side traffic pass through the OXCs, the individual and mean OXC costs may be characterized according to equations (42c) and (42d), which follow:
c_{oxc}=γₒₚP, (42c)
and so [symbol]
c_{oxc} [symbol] =γₒₚ [symbol] P [symbol] . (42d)
Substituting variables to obtain an expression that is independent of the demand model, the total cost of the OXCs may be characterized according to equation (42e), which follows:
C_{OXC}(N)= [symbol] c_{oxc} [symbol] N=2γₒₚD(N)[(2+ [symbol] κ [symbol] ) [symbol] h [symbol] ], (42e)
where D(N) is the number of two-way demands.

As in the other examples, a cost structure for the optical cross-connect consisting of a startup term and a growth term may also be considered and may be characterized according to equation (42f), which follows:
c_{oxc}=γₒ₀+γₒ₁P (42f)
In this case the mean and total cost of the OXCs may be characterized according to equations (42g) and (42h), which follow: [symbol]
c_{oxc} [symbol] =γₒ₀+γₒ₁ [symbol] P [symbol] (42g)
and
C_{OXC}(N)= [symbol] c_{oxc} [symbol] N=γₒ₀N+2γ₀₁D(N)[(2+ [symbol] κ [symbol] ) [symbol] h [symbol] ]. (42h)

Summing the electronic and optical bandwidth management costs, results in equation (43), which follows:
C_{BWM}(N,T)=(γₑ₀+γₒ₀)N+4γₑ₁T+2γₒ₁D(N)[(2+ [symbol] κ [symbol] ) [symbol] h [symbol] ]. (43)
Comparison of Costs for Example Node Architectures

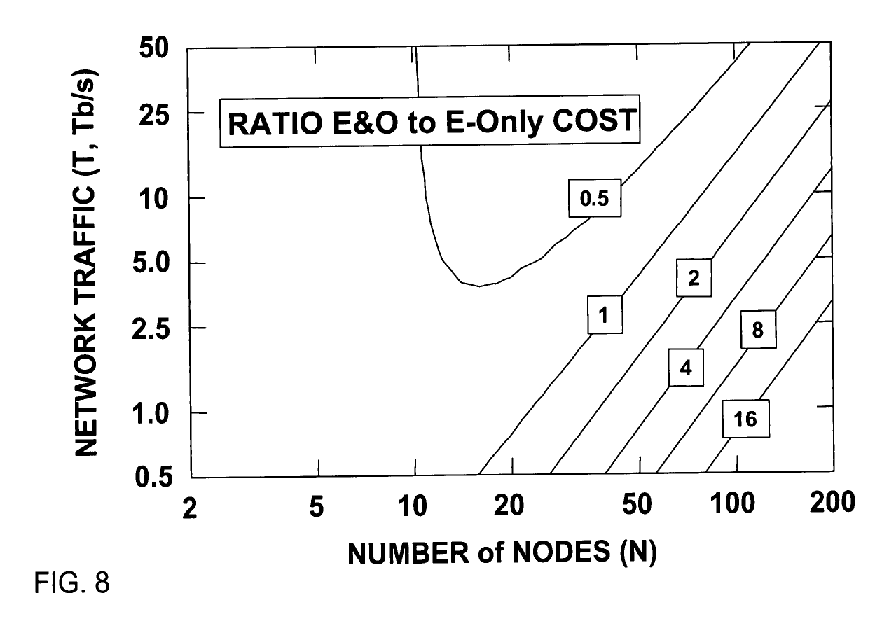

As an illustration of the application of the network global expectation model, the total costs for BWM for the two single-tier node architecture examples just described; namely electronic plus optical BWM and electronic-only BWM, are compared as a function of the number of nodes N and traffic T for fixed mean degree of node. The results of the calculations using the coarse cost structures for the EXC and OXC costs, equations (39b) and (42b), are graphed in FIG. 8.

FIG. 8 graphically depicts a plot of the total cost of bandwidth management using the combination of optical and electronic cross-connects compared to the total cost of bandwidth management using only an electronic cross-connect. The ratio is plotted as a function of the number of nodes, N, and two-way traffic, T. In the case of the optical and electronic architecture, it is assumed that all traffic follows through the optical switch fabric and additionally that all terminating traffic flows through the electronic switch fabric. The calculations performed and depicted in FIG. 8 are for uniform demand with restoration under the constraint [symbol] δ [symbol] =3.5. The cost structure (γ) used for the optical cross-connects and electronic cross-connects for this example are $2.5 K/port and $1 K/Gbps, respectively. It should be noted that these costs structures and values are rudimentary, intended to be illustrative, and should not be interpreted as definitive.

The network global expectation model of the present invention may be used to identify the region of the network parameter space where optical layer cross-connects may be introduced in conjunction with electronic cross-connects, or IP Routers, to economic advantage. The model accounts not only for the different characters of the cost structures as a function of traffic, but also accounts for the changing ratio of add/drop to through traffic as the number of nodes and links change. It is observed that for fixed values of the number of nodes for N greater than 15 that the total cost of bandwidth management using the electronic and optical (E&O) architecture decreases and becomes less than the cost of the electronic (E)-only solution as the total traffic increases. This is attributed to the assumption that the cost of an optical switch port is independent of channel bit-rate while the cost of an electronic switch port is directly proportional to the channel bit-rate. It is also observed that for fixed total network traffic that the cost of the E&O solution increases and becomes more expensive than the E-only solution as the number of nodes is increased and the mean degree of the nodes is held constant. This is because the mean termination-to-termination traffic decreases as the number of nodes is increased for fixed mean degree of the nodes (see FIG. 4), and consequently below some channel bit-rate, the fixed cost of an optical switch port becomes more expensive than an electronic switch port.

Of course, the details of the cost crossover depend upon the particulars of the technology price points (cost structure and coefficients), and consequently, the graph of FIG. 8 is intended only to demonstrate the capabilities and possibilities of the global expectation model and not to make a definitive recommendation. It should be noted that herein it has been implicitly assumed via the cost structures that the respective cross-connects technologies are capable of providing the required switch and backplane capacities. In the absence of more refined cost structures that account for these limitations, other equations and graphs of the model may be used, such the total number of required ports (equation (21b)) or the mean cross-connect traffic, to identify regions of the network traffic-node space that are beyond the capabilities of a particular architecture or technology.

Total Network Costs

The total network cost may be computed by summing the cost for transmission and bandwidth management using the formulae derived herein. For completeness equation 4 may be characterized according to equation (44), which follows:
C_{T}=C_{TRANS}+C_{BWM} (44)

Clearly, a useful attribute of the model is that the relative cost of transmission and bandwidth management can easily and quickly be determined.

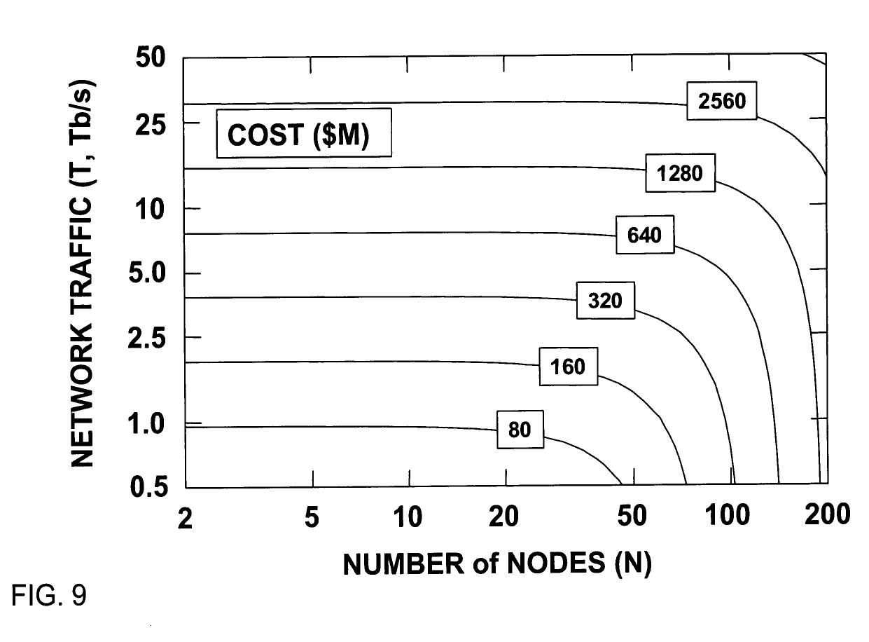

To illustrate the utility of the network global expectation model, FIG. 9 depicts a calculation of the total cost of a mesh network with uniform demand as a function of the number of nodes N and total traffic T. FIG. 9 graphically depicts a plot of the total cost of a mesh network with uniform demand as a function of the number of nodes N and total traffic T. The sum of transmission and bandwidth management equipment costs, C_{T}(N,T), is graphed as a function of the number of nodes, N, and total two-way traffic, T using a contour plot. As in FIG. 8, the calculations in FIG. 9 are for uniform demand with restoration under the constraint [symbol] δ [symbol] =3.5. The cost structures used for the optical line systems, electronic cross-connects, and optical cross-connects are $30/Gbps/km, $1 K/Gbps, and $2.5 K/port, respectively. Again, it should be noted that these cost structures and values are intended only to illustrate the capabilities and possibilities of the global expectation model of the present invention and should not be interpreted as definitive.

The results of FIG. 9 are for the case where the nodal bandwidth manager consists of a combination of optical layer and electronic cross-connects and the geographic area corresponds to the continental U.S. In the accounting, equations (33) and (34), equations (39b) and (39c), and equations (42b) and (42c) were used for the cost structure of the transmission links, electronic cross-connects, and optical cross-connects, respectively.

Among the features that may be observed by considering FIG. 9 is the impact of the cost of bandwidth management as the number of nodes increases. A qualitatively similar result is obtained for the case of electronic-only bandwidth management. Considering equation (22b) for total number of cross-connect ports and equation (30e) for the add/drop ratio, the large cost for large N may be interpreted to be a consequence of the single layer architecture. In effect, single-tier (flat) networks can not practically scale to very large number of nodes because as the number of nodes increases an increasing fraction of the traffic processed at each node is through traffic destined for other nodes. It is for this reason that the voice and packet networks are organized hierarchically based on geographic communities.

The underlying phenomenon may also be the driving factor behind more broadly observed scaling behavior of networks and biological systems. Clearly there are performance and operational tradeoffs between single-tier and multi-tier networks, and network operators will adjust the number of nodes and architecture in the backbone depending upon the costs for transmission and bandwidth management; changing cross-connect, line-system, and technology price points; and the evolution of traffic demand.

Refinement of Cost Structure and Evolution of Network Cost

In alternate embodiments of the present invention, the cost structure may be modified to account for the real-world implementation limits affecting maximum system capacities. Examples of such constraints are the maximum number of channels or wavelengths an optical line system is engineered for, or the maximum throughput of a switch fabric or backplane in the case of a cross-connect or router. Such hard bounds to network element capacity occur for any physical realization and have the effect of introducing quantum steps in the cost structure. When required capacities exceed the system capabilities, generally additional systems are deployed in parallel, and additional corresponding startup costs are incurred. Having developed a framework for the evaluation of the variances and distribution functions of key network variables earlier herein, a foundation has been provided to estimate the number of additional systems that are required given the network requirements and system bounds. Note too that in some instances the result of introducing these additional systems is to effectively increase the number of links or nodes of the network.

Furthermore, in alternate embodiment of the present invention, the network global expectation model of the present invention may be used for sensitivity analyses of the dependency of requirements and costs upon primary and secondary network and network element variables. The network global expectation model may also be used to compute the constituent and total network costs as a function of time. This requires only a model for how the total network traffic, number of nodes and links, and technology costs are expected to change. Some models for estimating how the total network traffic, number of nodes and links, and technology costs are expected to change are known in the art.

As previously mentioned, although the concepts of the present invention are being described herein with respect to communication networks, the concepts of the present invention may be applied to other networks and systems, such as power and commodity distribution and transportation systems.

The operations of the present invention may be performed by a general purpose computer that is programmed to perform various operational calculations and functions in accordance with the present invention. In addition, the calculations and functions of the present invention can be implemented in hardware, for example, as an application specified integrated circuit (ASIC). As such, the process steps described herein are intended to be broadly interpreted as being equivalently performed manually by a user or by software, hardware, or a combination thereof.

Furthermore, in an alternate embodiment of the present invention, the calculations, equations, and operations of the present invention herein may be loaded into the memory of a general purpose computer, along with instructions, for performing the operations and functions of the present invention. As such, the present invention comprises a computer program product.

While the forgoing is directed to various embodiments of the present invention, other and further embodiments of the invention may be devised without departing from the basic scope thereof. As such, the appropriate scope of the invention is to be determined according to the claims, which follow.

1. A method for quantifying the needs and costs of a network, comprising:
determining quantities of required network variables using closed-form mathematical expressions for network-wide expectation values for mean quantities of the network variables.

2. The method of claim 1, further comprising:
determining variations of a minimum number of required network variables using said mathematical expressions.

3. The method of claim 2, wherein the variance of the number of demands appearing on a link is determined using at least one of the following equations:
σ²(W^{o})≦ [symbol] W^{o} [symbol] [1−1/ [symbol] h [symbol] ];
σ(W_{B/E})/ [symbol] W_{B/E} [symbol] ≅\sqrt{[ [symbol] δ [symbol] ₙ [symbol] 1/δ [symbol] ₙ−1]/2};
σ_{d}(W^{o})/ [symbol] W^{o} [symbol] =[2/ [symbol] h [symbol] ][(σ(d)/ [symbol] d [symbol] ];
wherein [symbol] W^{o} [symbol] depicts the expectation value of the number of demands carried on the link, [symbol] h [symbol] depicts the expectation value of the number of hops on the link, [symbol] δ [symbol] depicts the average degree of nodes, and (d) depicts the mean number of demands terminating at a node.

4. The method of claim 2, wherein the variance of the ratio of terminated to through traffic is determined using the following equation: [symbol]
ρ′ [symbol] =2/[1+ [symbol] h [symbol] ];
wherein [symbol] h [symbol] depicts the expectation value of a number of hops on the network.

5. The method of claim 1, wherein said network variables are variables selected from the group consisting of network elements, subsystems and components.

6. The method of claim 1, wherein a communication demand model and a network graph, defined by a set of nodes and a set of links, provide inputs for the mathematical expressions.

7. The method of claim 1, wherein the mathematical expressions require inputs selected from the group consisting of a number of network nodes, a number of links and a number of demands in said network.

8. The method of claim 1, wherein said mathematical expressions comprise equations for calculating a local value of the number of demands appearing on a link or carried on a means of transmission.

9. The method of claim 8, wherein the number of demands is determined using the following equation: [symbol]
W^{o} [symbol] = [symbol] d [symbol] [symbol] h [symbol] / [symbol] δ [symbol] ;
wherein [symbol] h [symbol] depicts the expectation value of the number of hops on the link, [symbol] δ [symbol] depicts the average degree of nodes in the network, and [symbol] d [symbol] depicts the mean number of demands terminating at a node.

10. The method of claim 8, wherein said demands comprise at least one demand selected from the group consisting of uniform demands, random demands, and distance dependent demands.

11. The method of claim 8, wherein said means of transmission comprises an optical line system or a multi-wavelength optical line system.

12. The method of claim 1, wherein said mathematical expressions comprise equations for calculating a mean number of hops.

13. The method of claim 12, wherein said mean number of hops is determined using the following equation: [symbol]
h [symbol] ≅\sqrt{(N−2)/( [symbol] δ [symbol] −1)},
wherein N depicts a number of nodes in the network, and [symbol] δ [symbol] depicts the average degree of the nodes.

14. The method of claim 1, wherein said mathematical expressions comprise equations for calculating a global mean value or a local value of a number of transmission subsystems.

15. The method of claim 1, wherein said mathematical expressions comprise equations for calculating a variance of the number of transmission subsystems.

16. The method of claim 1, wherein said mathematical expressions comprise equations for calculating a global mean value and/or a variance of a number of demands present at a node or connected to a means of bandwidth management.

17. The method of claim 16, wherein said demands comprise at least one demand selected from the group consisting of uniform demands, random demands, and distance dependent demands.

18. The method of claim 16, wherein said means of bandwidth management comprises a means selected from the group consisting of an electronic cross-connect, an IP router, a multi-service platform, an optical cross-connect, an optical router, and an optical add/drop multiplexer.

19. The method of claim 16, wherein said means of bandwidth management comprises a combination of electronic and optical bandwidth management.

20. The method of claim 1, wherein said mathematical expressions comprise equations for calculating a value of the number of demands present at a node or connected to a means of bandwidth management.

21. The method of claim 20, wherein the number of demands present at a node is determined using the following equation: [symbol]
P^{κ} [symbol] = [symbol] d [symbol] + [symbol] W^{o} [symbol] (1+ [symbol] κ [symbol] ) [symbol] δ [symbol] ;
wherein [symbol] W^{o} [symbol] depicts the expectation value of the number of demands carried on a link, [symbol] κ [symbol] depicts the extra capacity for restoration, [symbol] δ [symbol] depicts the average degree of nodes in the network, and [symbol] d [symbol] depicts the mean number of demands terminating at a node.

22. The method of claim 20, wherein said demands comprise at least one demand selected from the group consisting of uniform demands, random demands, and distance dependent demands.

23. The method of claim 20, wherein said means of bandwidth management comprises a means selected from the group consisting of an electronic cross-connect, an IP router, a multi-service platform, an optical cross-connect, an optical router, and an optical add/drop multiplexer.

24. The method of claim 20, wherein said means of bandwidth management is a combination of electronic and optical bandwidth management.

25. The method of claim 1, wherein said mathematical expressions comprise equations for calculating a global mean value or a local value of a number of bandwidth management subsystems.

26. The method of claim 1, wherein said mathematical expressions comprise equations for calculating a variance of the number of bandwidth management subsystems.

27. The method of claim 1, wherein said mathematical expressions comprise equations for calculating a global mean value of the extra capacity necessary for network survivability.

28. The method of claim 1, wherein the global mean value of extra capacity is determined using at least one of the following equations: [symbol]
κ [symbol] ≅2/ [symbol] δ [symbol] ; [symbol]
κ [symbol] ≅4 [symbol] h [symbol] /L;
wherein [symbol] δ [symbol] depicts the average degree of nodes in the network and [symbol] h [symbol] depicts the mean number of hops.

29. The method of claim 1, wherein said mathematical expressions comprise equations for calculating a local value of the extra capacity required on a link or means of transmission for network survivability

30. The method of claim 1, wherein said mathematical expressions comprise equations for calculating a cost of transmission of demands across the network.

31. The method of claim 1, wherein said mathematical expressions comprise equations for calculating a cost of bandwidth management of demands across the network.

32. The method of claim 1, wherein said mathematical expressions comprise equations for calculating a ratio of cost of electronic and optical bandwidth management.

33. The method of claim 1, wherein said mathematical expressions comprise equations for calculating a ratio of cost of transmission and bandwidth management.

34. The method of claim 1, wherein said mathematical expressions comprise equations for calculating a cost of the network.

35. The method of claim 1, wherein said network comprises a network selected from the group consisting of a two-dimensional-single-tier mesh network, a two-dimensional-multi-tier network, a multi-dimensional network, and a multi-dimensional-multi-tier network.

36. A computer-readable medium for storing a set of instructions, which when executed by a processor, perform a method comprising:
determining quantities of required network variables using closed-form mathematical expressions for network-wide expectation values for mean quantities of the network variables.

37. The computer readable medium of claim 36, wherein said method further comprises:
determining variations of a minimum number of required network variables using said mathematical expressions.

38. A computer program product loadable into a computer for quantifying the needs and costs of a network, the computer program product comprising software for performing the step of:
determining quantities of required network variables using closed-form mathematical expressions for network-wide expectation values for mean quantities of the network variables.
